(19) United States
(12) Patent Application Publication
(10) Pub. No.: US 2009/0249021 A1
(43) Pub. Date: Oct. 1, 2009

(54) Method And Systems For Invoking An Advice Operation Associated With A Joinpoint

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/055,550

(22) Filed: Mar. 26, 2008

(51) Int. Cl. G06F 9/30; G06F 12/00

(52) U.S. Cl. 711/202; 712/233; 711/200; 711/E12.001; 712/E09.016

(57) ABSTRACT

Methods and systems are described for invoking an advice operation associated with a joinpoint. In one embodiment, the method includes identifying, based on a pointcut specification included in an aspect specification, a joinpoint in a machine code program component. The joinpoint includes a machine code instruction. The method further includes identifying, based on an advice specification included in the aspect specification, an advice operation included in a machine code program component. The method still further includes detecting an access to the machine code instruction in the joinpoint for execution by a processor. The method also includes invoking the advice operation in association with detecting the access to the machine code instruction.

### RELATED APPLICATIONS

This application is related to co-pending U.S. patent application Ser. No. 11/478,907 entitled “METHODS, SYSTEMS, AND COMPUTER PROGRAM PRODUCTS FOR ENABLING CROSS LANGUAGE ACCESS TO AN ADDRESSABLE ENTITY”, filed on Jun. 30, 2006, assigned to the assignee of the present application; U.S. patent application Ser. No. 11/428,338 entitled “METHODS, SYSTEMS, AND COMPUTER PROGRAM PRODUCTS FOR PROVIDING ACCESS TO ADDRESSABLE ENTITIES USING A NON-SEQUENTIAL VIRTUAL ADDRESS SPACE”, filed on Jun. 30, 2006, assigned to the assignee of the present application; co-pending U.S. patent application Ser. No. 11/428,280 entitled “METHODS, SYSTEMS, AND COMPUTER PROGRAM PRODUCTS FOR GENERATING AND USING OBJECT MODULES”, filed on Jun. 30, 2006, assigned to the assignee of the present application; co-pending U.S. patent application Ser. No. 11/428,273 entitled “METHODS, SYSTEMS, AND COMPUTER PROGRAM PRODUCTS FOR PROVIDING A PROGRAM EXECUTION ENVIRONMENT”, filed on Jun. 30, 2006, assigned to the assignee of the present application; co-pending U.S. patent application Ser. No. 11/428,324 entitled “METHODS, SYSTEMS, AND COMPUTER PROGRAM PRODUCTS FOR USING A STRUCTURED DATA STORAGE SYSTEM TO PROVIDE ACCESS TO ADDRESSABLE ENTITIES IN A VIRTUAL ADDRESS SPACE”, filed on Jun. 30, 2006, assigned to the assignee of the present application; the entire disclosures of which are here incorporated by reference.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

In software engineering, separation of concerns is considered good practice. Separation of concerns is typically performed by dividing a program into pieces that have as little overlap in function as possible. Data structures, functions, classes, and methods are examples of programming language constructs that support separation of concerns. Aspect-oriented programming (AOP) provides support for separating concerns that cross-cut a program and/or software system. AOP provides this support through extensions to existing programming languages or by new languages designed to support AOP. Prior to AOP, cross-cutting concerns were difficult, if not impossible, to encapsulate or separate from non-distinct functionality. Examples of cross-cutting functionality include logging, security, transaction support, and performance profiling.

AOP languages are typically used to modify programs written in a compatible language to add “aspects” supporting the operation of cross-cutting concerns to the functionality of the compatible language. For example, AspectJ is an example AOP language that specifically adds AOP support to programs written in Java. Some AOP languages are combined with a compatible language at the source code level to produce a combined source valid in the compatible language. The combined source code is interpreted or compiled, loaded, and linked in an execution environment to produce a machine code program component for executing the instructions expressed in the AOP language and its compatible partner language. This process is known as source-code weaving. Other languages such as Java allow weaving to occur at the byte code level during the build process and/or at load-time as in per-class byte code weaving currently supported by AspectJ.

All current AOP mechanisms are specific to a programming language as AspectJ is to Java. Thus adding logging support to a number of executables in an execution environment generated from source code written in different programming languages is difficult, if not impossible, in some cases. Further, many languages have no associated AOP language extensions. AOP support for languages that do have AOP extensions differs in terms the types of pointcuts that can be defined, the safety of the AOP language, and the usability of the AOP languages. Usability of AOP languages is a significant issue and is at least partially responsible for the slow adoption of AOP despite its potential usefulness.

### SUMMARY

Methods and systems are described for invoking an advice operation associated with a joinpoint. In one embodiment, the method includes identifying, based on a pointcut specification included in an aspect specification, a joinpoint in a machine code program component. The joinpoint includes a machine code instruction. The method further includes identifying, based on an advice specification included in the aspect specification, an advice operation included in a machine code program component. The method still further includes detecting an access to the machine code instruction in the joinpoint for execution by a processor. The method also includes invoking the advice operation in association with detecting the access to the machine code instruction.

Further, a system for invoking an advice operation associated is described. The system includes an aspect binder component configured for identifying, based on a pointcut specification included in an aspect specification, a joinpoint in a machine code program component. The joinpoint includes a machine code instruction. The aspect binder component is further configured for identifying, based on an advice specification included in the aspect specification, an advice operation included in a machine code program component. The system further includes an access detector component configured for detecting an access to the machine code instruction in the joinpoint for execution by a processor. The access detector component is further configured for invoking the advice operation in association with detecting the access to the machine code instruction.

### BRIEF DESCRIPTION OF THE DRAWINGS

FIG. 1 is a flow diagram illustrating a method for invoking an advice operation associated with a joinpoint according to an embodiment of the subject matter described herein;

FIG. 2 is a block diagram illustrating a system for invoking an advice operation associated with a joinpoint according to another embodiment of the subject matter described herein;

FIG. 3 illustrates an exemplary aspect configuration including a pointcut specification and an associated advice specification for invoking an advice operation associated with a joinpoint according to an embodiment of the subject matter described herein;

FIG. 4 is a block diagram illustrating a system for invoking an advice operation associated with a joinpoint according to another embodiment of the subject matter described herein;

FIG. 5 is a block diagram illustrating a system for invoking an advice operation associated with a joinpoint according to another embodiment of the subject matter described herein;

FIG. 6A is a block diagram illustrating a system for invoking an advice operation associated with a joinpoint according to another embodiment of the subject matter described herein;

FIG. 6B is a block diagram illustrating a system for invoking an advice operation associated with a joinpoint according to another embodiment of the subject matter described herein;

FIG. 6D is a block diagram illustrating a system for invoking an advice operation associated with a joinpoint according to another embodiment of the subject matter described herein;

FIG. 7 illustrates an exemplary aspect configuration including a pointcut specification and an associated advice specification for invoking an advice operation associated with a joinpoint according to an embodiment of the subject matter described herein;

FIG. 8 is a flow diagram illustrating a method for invoking an advice operation associated with a joinpoint according to another embodiment of the subject matter described herein; and

FIG. 9 is a block diagram illustrating a system for invoking an advice operation associated with a joinpoint according to another embodiment of the subject matter described herein.

### DETAILED DESCRIPTION

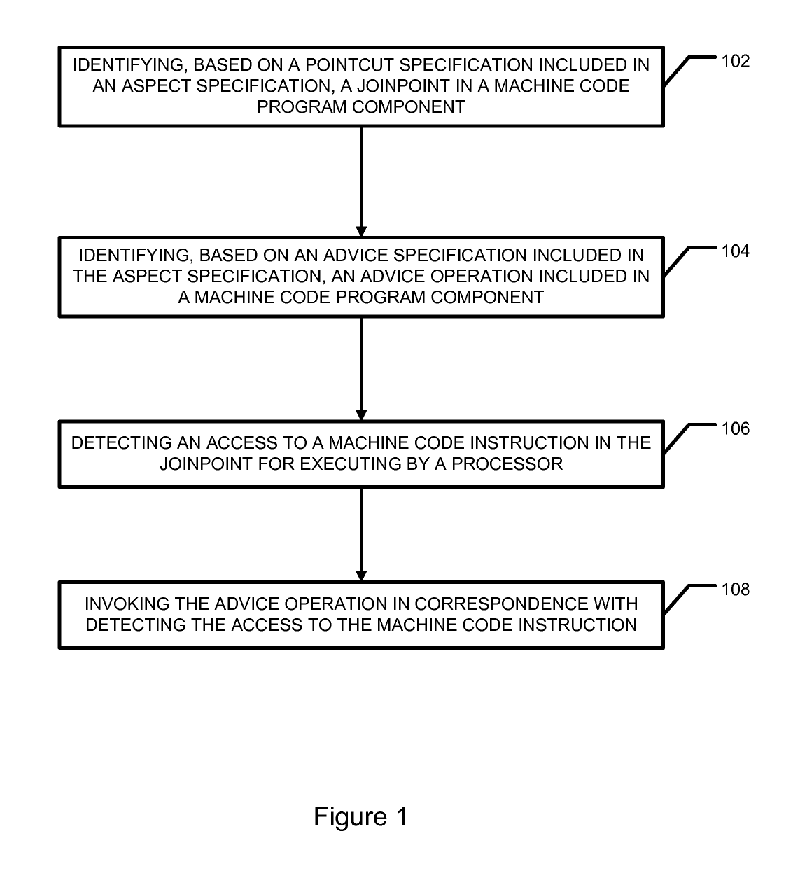

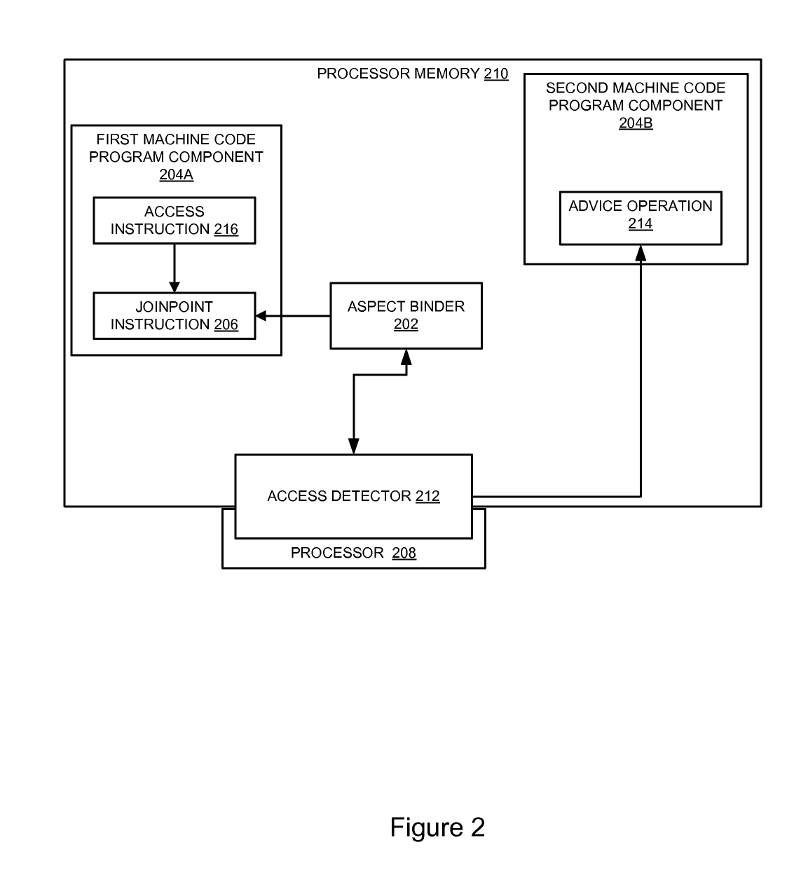

FIG. 1 is a flow diagram illustrating a method for invoking an advice operation associated with a joinpoint according to an exemplary embodiment of the subject matter described herein. FIG. 2 is a block diagram illustrating a system for invoking an advice operation associated with a joinpoint according to another exemplary embodiment of the subject matter described herein. The method illustrated in FIG. 1 can be carried out by, for example, some or all of the components illustrated in the exemplary system of FIG. 2.

With reference to FIG. 1, in block 102 a joinpoint in a machine code program component is identified based on a pointcut specification included in an aspect specification. The joinpoint includes a machine code instruction. Accordingly, a system for invoking an advice operation associated with a joinpoint includes means for identifying a joinpoint in a machine code program component. For example, as illustrated in FIG. 2, an aspect binder component 202 is configured for identifying a joinpoint in a machine code program component.

A joinpoint is a point in the control flow of a machine code program component where one or more attributes accessible for processing match a pointcut specification. In Aspect Oriented Programming (AOP), a set of joinpoints is referred to as a pointcut. A pointcut specification, thus, is processed in identifying a joinpoint. A joinpoint can be identified at a point in time in the control flow before, during, or after the execution of a machine code instruction associated with the joinpoint by a processor. Such a machine code instruction is referred to as a joinpoint instruction (JPI). An addressable entity including a JPI is referred to as a joinpoint addressable entity (JPAE).

Addressable entities can be defined using source code for generating a machine code program component. Some examples of addressable entities (a non-exhaustive list) include: variables such as structures, constants including structured constants, functions, subroutines, methods, classes, anonymous scoped machine code instruction sets, and individual machine code instructions that can be labeled. An addressable entity includes a value or a machine code instruction, but is not the value or the machine code instruction itself.

Addressable entities can have a number of corresponding formats. These formats include: source code, machine code, and any intermediate formats used by an interpreter, compiler, linker, loader, or equivalent tool. An Addressable entity (AE) is any data that can be stored in a processor memory location of an execution environment and located/addressed using an identifier associated with the processor memory location for processing by a processor. The term processor memory can refer to either virtual or physical memory accessible via a processor through a processor supported address space. The term refers to the memory associated with the address space of a runtime environment (also known as an execution environment) that can be a virtual execution environment. Persistent memory refers to persistent, secondary storage such as storage provided by a hard drive. Processor memory in some virtual address spaces can include or span both volatile memory, such as Random Access Memory (RAM), and persistent memory.

A pointcut specification and an associated advice specification can be referred to as an aspect specification. An aspect specification including a pointcut specification and an associated advice specification can be specified using a variety of formats, syntaxes, and vocabularies. For example, a schema can be provided for defining a valid format, syntax, and vocabulary of a valid aspect specification. A pointcut specification and an advice specification can be specified together using a common aspect schema including a pointcut schema for configuring a valid pointcut specification conforming to the schema for pointcut specifications, and an advice schema for configuring a valid advice specification conforming to the schema for advice specifications. The pointcut specification is used for identifying a joinpoint included in a machine code program component written in any of a plurality of programming languages. The advice specification is for identifying an advice operation included in a machine code program component written in any of a plurality of programming languages. Alternatively, the pointcut specification and the advice specification can be specified separately based on separate schemas.

An aspect specification can include a markup element included in a markup language, a command included in a command language, and/or a keyword-value pair based on a pointcut schema and an advice schema for configuring a valid aspect specification conforming to the schemas. For example, a pointcut specification can be specified in a markup language such as an XML based language and an associated advice specification can be specified using a keyword-value pair based specification language, or vice versa. Alternatively, a schema for configuring a valid pointcut and/or an advice specification can provide a command language for configuring the pointcut and/or the advice specification. An example of a structured query language (SQL) like command language is described below.

A machine code program component 204, such as a first machine code program component 204A in FIG. 2, can be generated from source code written in any of a plurality of programming languages, such as processor independent languages C, C#, C++, FORTRAN, COBOL, LISP, FP, JAVA®, and various processor family specific assembly languages. Processor independent programming language, as used herein, refers to a programming language from which a plurality of machine code representations can be generated from a single source written in the programming language. Each machine code representation in the plurality is executable on a processor from a different processor family, such as the Intel® x86 processor family, or the PowerPC® processor family. For the purposes of this document, processors will be considered to be in the same family if they are able to process a machine representation of a source written in a common portion of an assembly language. Thus, an 80286 processor and an 80586 processor are considered to be in the same family, as both can run a machine code representation executable on the 80286 processor.

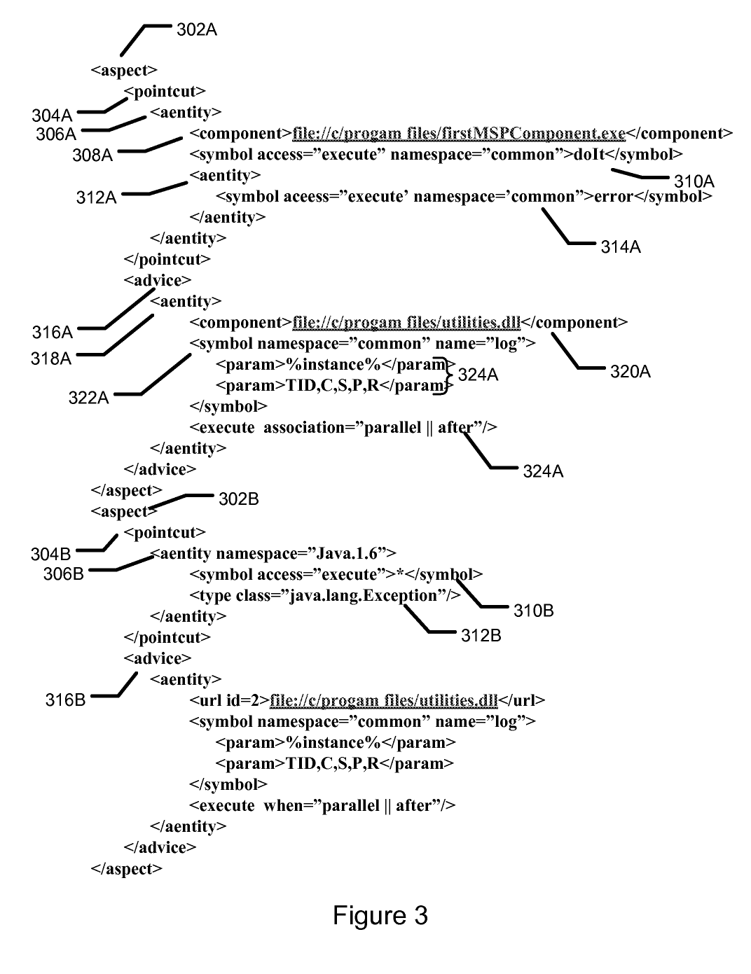

FIG. 3 illustrates an exemplary XML markup language based aspect configuration document including two aspect specifications. Each aspect specification depicted can be bounded by an <aspect> element 302A and 302B respectively. Each <aspect> element can include a pointcut specification bounded by a <pointcut> 304 element. The pointcut specifications illustrated in FIG. 3 are based on an XML markup language defined by a schema for configuring pointcut specifications. The aspect binder 202 can be configured for receiving, providing for storing and validating that the pointcut specifications conform to the associated schema for pointcut specifications. The aspect binder 202 can be configured for identifying joinpoints in a machine code program component 204A or 204B based on the pointcut specifications in FIG. 3.

In the exemplary arrangement illustrated in FIG. 2, the aspect binder 202 identifies a joinpoint based on a pointcut specification, such as the pointcut specification bounded by the <pointcut> element 304A. An identified joinpoint includes a machine code instruction 206 that is associated with the aspect specification including the pointcut specification. The machine code instruction 206 is labeled in FIG. 2 as a joinpoint instruction (JPI) 206.

An aspect specification can include a matching criterion based on an attribute accessible to the aspect binder 202 for identifying a joinpoint and/or and an advice operation. The matching criterion can be based on accessible attributes including an attribute of an addressable entity, an attribute of a relationship between or among a plurality of addressable entities, and an execution environment attribute. The matching criterion can include an expression, such as an expression specifying a conditional test based on an attribute. The matching criterion can be based on a type of the addressable entity indicating a data type or whether a matching addressable entity is executable; a value of an input and/or output parameter, and/or a value of a return value of a function. The matching criterion can be based on a relationship between or among a plurality of addressable entities such as a scope of an addressable entity defined with respect to one or more other addressable entities. The matching criterion can be based on an execution environment attribute such as a specified system time, a measure of processor memory usage, and/or a measure of processor utilization. The matching criterion can be based on a condition such as a conditional test that is true when a value of an instance variable parameter is greater than a specified threshold value.

Further, an aspect specification including a pointcut specification and an advice specification can include a value attribute including an acceptable value of an addressable entity, a scope attribute identifying a portion of the executable program component wherein the addressable entity is known, and a symbol attribute including an identifier of the addressable entity.

Referring again to FIG. 3, the pointcut specification represented by the <pointcut> element 304A and its content includes an <aentity> element 306A based on a schema for configuring pointcut specifications. The <aentity> element 306A, according to the associated pointcut schema, is for identifying an addressable entity based on determining a match between the <aentity> specification and an attribute accessible to the aspect binder 202. Matching criteria for matching an addressable entity are included as content in the exemplary <aentity> element 306A. The matching criteria include a <component> element 308A matching the first machine code program component 204A, based on a file URL matching criterion.

The matching criteria in the <pointcut> element 304A also include a <symbol> element 310A for including an expression as a matching criterion for matching a symbol. The symbol can be associated with one or more addressable entities in the matching first machine code program component 204A. The matching expression can be a string with or without wildcard characters and/or can be a regular expression or an analog of a regular expression. The expression matches a name or names included in a “common” namespace as indicated by a “namespace” attribute included in the <symbol> element 310A. In the pointcut specification as specified by the <pointcut> element 304A the matching expression matches a symbol “dolt”.

The aspect binder 202 can be configured for matching addressable entity symbol names using a shared namespace based on the use of alias symbols, as disclosed in co-pending U.S. patent application Ser. No. 11/478,907 entitled “METHODS, SYSTEMS, AND COMPUTER PROGRAM PRODUCTS FOR ENABLING CROSS LANGUAGE ACCESS TO AN ADDRESSABLE ENTITY.” An alias symbol is for identifying addressable entities across multiple programming language symbol namespaces. A shared namespace includes symbols for associating with and or included as references in multiple addressable entities.

An “access” attribute can be included in the <symbol> element 310A for allowing the pointcut specification 304A to specify an access type to be matched for identifying a joinpoint. The “execute” value included in the <symbol> element 310A indicates that a matching access is an access for executing a matching addressable entity. An <aentity> element 312A depicted in the pointcut specification 304A can be nested inside the <aentity> element 306A for indicating a further condition for identifying a joinpoint. According to the pointcut specification included in the <pointcut> element 304A, a joinpoint can be identified when an addressable entity matching the common name “dolt” included in the first machine code program component 204A is in an execution state where it will invoke, is invoking, or has invoked a second addressable entity identified by the nested <aentity> element 312A with a name “error” from a “common” namespace. A matching access is an access for executing the “error” addressable entity by a processor 208 as indicated by the “execute” value assigned to the “access” attribute in the <symbol> element 314A.

The JPI 206 can be in an instance of an addressable entity. The instance can be one of multiple instances of the addressable entity. The joinpoint may not exist in one or more of the other instances included in the multiple instances. For example, a joinpoint can be identified based on the pointcut specification 304A when the aspect binder 202 is configured for determining an execution state is associated with a machine code instruction, such as the JPI 206. The aspect binder 202 can determine the machine code instruction 206 is in an addressable entity associated with the common name “dolt” included in the first machine code program component 204A. Further, the aspect binder 202 can determine that the machine code instruction 206 is at an execution point associated with a call to an addressable entity associated with the symbol “error” from a “common” namespace. The aspect binder 202 can be further configured for determining that an instance of “dolt,” that when executed does not call the “error” addressable entity, does not include a joinpoint. Thus, some instances of the “dolt” addressable entity can include an identified joinpoint and some instances can be identified to not include a joinpoint When a joinpoint or a potential joinpoint is identified, the machine code instruction 206 is referred to as a JPI 206, as discussed above, and the including addressable entity is referred to as a JPAE 408.

The aspect binder 202 can be configured for identifying a potential joinpoint and/or potential JPI. A potential joinpoint can be identified when the joinpoint binder 202 is configured for identifying a partial match during an identification operation but does not complete the identification during the determination operation. A potential joinpoint and potential JPI can be identified prior to execution of a machine code program component 204 when a matching criterion included in an associated pointcut specification is based at least in part on an attribute accessible to the aspect binder 202 prior to execution of a portion of the machine code program component 204 in which the potential joinpoint can be identified.

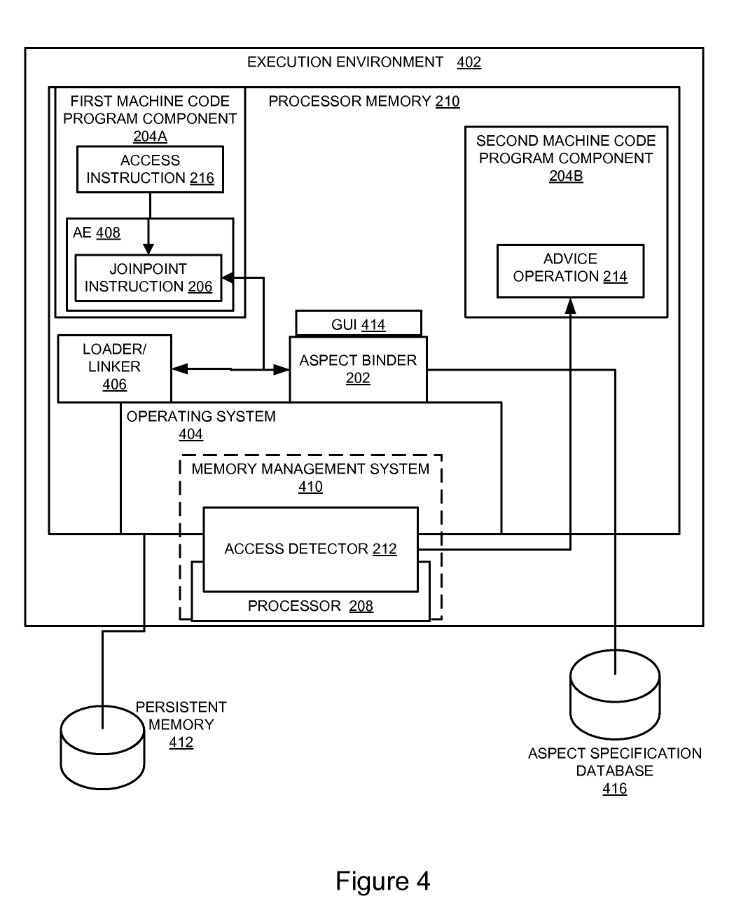

Referring now to FIG. 4, a block diagram illustrating an arrangement of components at least a portion of which are for providing advice for a joinpoint according to the method illustrated in FIG. 1. The method illustrated in FIG. 1 can be carried out by, for example, some or all of the components illustrated in the exemplary arrangement illustrated in FIG. 4. The arrangement illustrated in FIG. 4 includes the components of the arrangement illustrated in FIG. 2 adapted for operating in the arrangement in FIG. 4. The arrangement illustrated in FIG. 4 includes additional components for performing additional operations and providing additional features.

The arrangement illustrated in FIG. 4 includes an execution environment 402 supporting the operation of the first machine code program component 204A. The exemplary execution environment 402 includes a processor 208, a processor memory 210 such as a virtual memory, and an operating system 404 or control program configured for managing the resources of the execution environment 402. The execution environment 402 can include additional and/or alternative components and subsystems, such as a network stack, based on the requirements of the particular device hosting the execution environment 402. The execution environment 402 can be configured for supporting the processing of executables such as applications and machine code libraries.

In the arrangement illustrated in FIG. 4, the aspect binder 202 can be configured for identifying the machine code instruction 206 as the JPI 206 associated with a joinpoint based on the pointcut specification 304A. Note that the JPI 206 can be a potential JPI that is only a JPI if an additional criterion is met. Similarly a potential joinpoint is a joinpoint only if an additional criterion is met. Joinpoint and JPI, as used in this document, include joinpoints, JPI's, potential joinpoints, and potential JPI's. The JPI 206 can be loaded into a processor memory location of the processor memory 210 by a loader/linker 406 component included in the execution environment 402 as depicted in FIG. 4. The JPI 206 can be included in an addressable entity depicted as an addressable entity 408. The addressable entity 408 can be included in the first machine code program component 204A. The addressable entity 408 and its included JPI 206 are loaded into the processor memory 210. Any unresolved references are resolved by the loader/linker 406. The addressable entity 408 including the JPI 206 can be accessed by the processor 208 when loaded into the processor memory 210.

Aspect information based on an aspect specification can be associated with a processor memory location of an identified JPI 206. The aspect binder 202 can be configured for associating an identified joinpoint or an identified potential joinpoint with (a processor memory location including) the JPI 206. The aspect binder 202 can provide for creating the association by associating aspect information with the JPI 206. The association of aspect information with the JPI 206 can be made via an access detector 212 described in detail below.

The location in the processor memory 210 of the JPI 206 can be associated with an address from an address space supported by the processor 208 and a memory management system (MMS) 410. An address from the address space identifies a processor memory location in the processor memory 210 managed by the MMS 410. The processor 208 can be configured for accessing the content of the processor memory location based on the address. The address can be a virtual processor memory address included in a structured memory address space, a non-sequential memory address space, and/or a sequential memory address space as described in more detail below.

The aspect information is based on the aspect specification 302A including the pointcut specification 304 illustrated in FIG. 3. An associated pointcut schema defines the structure and content of valid pointcut specifications for identifying joinpoints included in machine code program components 204. A machine code program component 204, such as the first machine code program component 204A, can be generated from source code written in any of a plurality of programming languages. A particular pointcut specification can be provided for detecting joinpoints in machine code program components 204, each generated from source code written in a different programming language.

Machine code can bear little resemblance to source code and intermediate representations from which it can be generated, loaded, and/or linked. Metadata associated with the machine code program component 204A such as type information and symbol names is typically not present in a machine code representation of a program component loaded and linked in processor memory 210 for execution. Identifying a joinpoint in a machine code program component 204 can be enhanced by associating metadata with the machine code program component 204. The metadata can include machine code instructions, data derived from machine code instructions, addressable entities, other machine code program components 204, and data accessible from an execution environment and its included components. Further, an aspect specification can be based on metadata associated with a machine code program component 204 for identifying a joinpoint and/or an advice operation in the machine code program component 204.

The metadata can include at least portion of information that can be included in source code and intermediate representations of a machine code program component for identifying joinpoints based on a pointcut specification. Systems and methods for providing structured processor memory and/or non-sequential processor memory are described in co-pending U.S. patent application Ser. No. 11/428,338 entitled “METHODS, SYSTEMS, AND COMPUTER PROGRAM PRODUCTS FOR PROVIDING ACCESS TO ADDRESSABLE ENTITIES USING A NON-SEQUENTIAL VIRTUAL ADDRESS SPACE”,; co-pending U.S. patent application Ser. No. 11/428,280 entitled “METHODS, SYSTEMS, AND COMPUTER PROGRAM PRODUCTS FOR GENERATING AND USING OBJECT MODULES”; co-pending U.S. patent application Ser. No. 11/428,273 entitled “METHODS, SYSTEMS, AND COMPUTER PROGRAM PRODUCTS FOR PROVIDING A PROGRAM EXECUTION ENVIRONMENT”,; co-pending U.S. patent application Ser. No. 11/428,324 entitled “METHODS, SYSTEMS, AND COMPUTER PROGRAM PRODUCTS FOR USING A STRUCTURED DATA STORAGE SYSTEM TO PROVIDE ACCESS TO ADDRESSABLE ENTITIES IN A VIRTUAL ADDRESS SPACE.” Structured processor memory is associated with metadata analogous to storage in a structure data storage system (SDSS) such as a Structured Query Language (SQL) Database Management System (DBMS). A SQL database is based on metadata in that table names, column names, and column data types, for example, are metadata associated with the content of the table's rows and columns.

Alternatively, as source code is translated to loaded and linked machine code instructions and data by the build tools, data accessible in the source code and/or in any intermediate representation of the source code can be stored as metadata. Memory maps and symbol tables generated in a compile/link/load process include at least a portion of the available metadata lost in the generated machine code representation. The use of structured processor memory and/or the use of a memory map along with a symbol table in performing the method illustrated in FIG. 1 are described below in combination with marking memory including a joinpoint and/or potential joinpoint.

The MMS 410 can be configured to map addresses assigned to processor memory 210 locations to volatile memory including various types of RAM. The MMS 410 can be further configured for storing any portion of processor memory 210 not mapped to volatile memory in a swap file stored in a persistent memory 412, such as a hard drive. As indicated, a memory map can add metadata for performing the method illustrated in FIG. 1. Alternatively, the MMS 410 can be configured for mapping an address space so that processor memory 210 is structured, rather than being a sequential address space referencing processor memory as bytes and/or words. A MMS 410 based on structured processor memory can be configured for addressing addressable entities as entities rather than or in addition to addressing bytes and/or words. Further, a MMS 410 based on structured processor memory can be configured for managing processor memory 210 that spans both volatile storage and persistent memory 412. The MMS 410 can be configured for mapping the processor address space entirely to persistent memory 412 with RAM serving as a cache. In such a configuration, the processor memory 210 includes RAM and persistent memory 412. Accordingly, at least a portion of the persistent memory 412 is included in the processor memory 210 along with RAM. The MMS 410 can be configured for including an SDSS based memory management system to provide an address space that spans volatile and persistent memory 412 extending processor memory 210 across various types of physical memory.

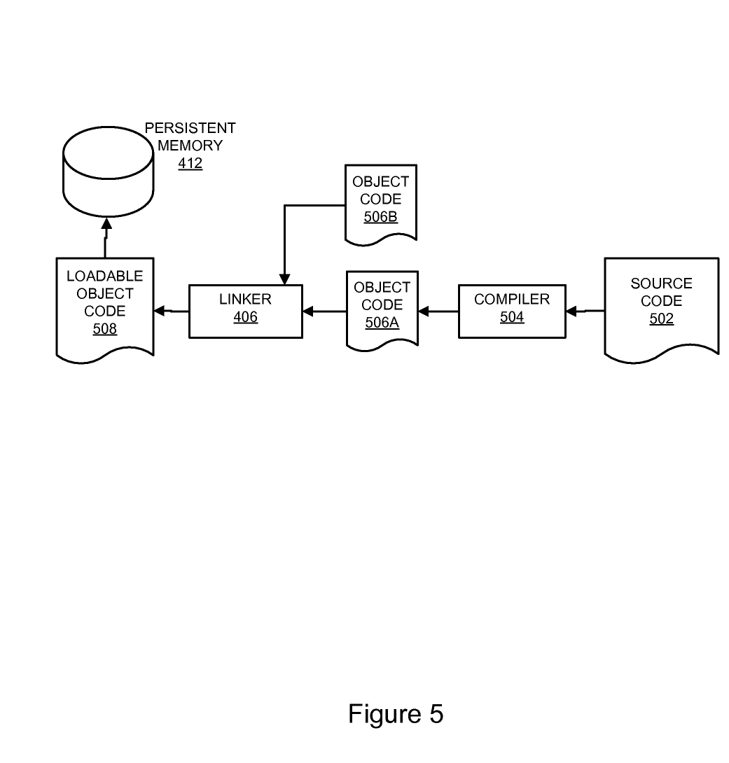

Referring now to FIG. 5, the machine code program component 204A can be a representation of and generated from the source code 502 depicted in FIG. 5. The source code 502 can be written in any of a variety of programming language. The programming language can be processor independent. If the program source code 502 is written in a compilable programming language, such as ‘C’, then the machine code program component 204A including the addressable entity 408 can be generated through a process of compiling the source code 502 using a compiler 504 resulting in an object code 506A representation. The object code 506A representation can be linked, if needed, with another object code 506B representation generated from another source code (not shown), using a linker 406 producing a loadable object code 508 representation that can be stored in a persistent memory 412. Interpreted programming languages are based upon similar principals and processes and are considered within the scope of this document. The generation of the loadable object code 508 can be performed by build tools hosted in the execution environment 402 and/or can be generated by build tools hosted in another execution environment provided by another device or the same device that hosts the execution environment 402 using a virtualization environment.

The loader/linker 406 can be configured for creating the machine code program component 204A in the processor memory 210 by interoperating with the MMS 410 to load the loadable object code 508 from the persistent memory 412 into locations in the processor memory 210 included in the execution environment 402. Systems and methods for generating the loadable object code 508 compatible with a structured processor memory are described in above cited co-pending U.S. patent application Ser. No. 11/428,280.

The loader/linker 406 can be configured for loading the loadable object code 508 into one or more processor memory locations in the processor memory 210 according to the configured memory address space and the MMS 410. During the process of loading, the loader/linker 406 and/or the MMS 410 can reserve a processor memory location that is associated with the addressable entity 408 of the machine code program component 204A. During loading and/or linking a value associated with the addressable entity 408 can be stored in the associated location of the processor memory 210. Thus, each machine code instruction, such as the machine code instruction 206, in an addressable entity, such as the addressable entity 408, can be associated with a location in the processor memory 210.

If the machine code program component 204A including the addressable entity 408 includes any unresolved references to addressable entities within and/or external to the machine code program component 204A, a load-time and/or run-time linking process can be performed. The linking process can be performed by a linking component of the loader/linker 406 configured for resolving the unresolved references. The resolved references allow the processor 208 to execute the machine code instructions included in the first machine code program component 204A including the machine code instruction 206.

Addressable entities, such as the addressable entity 408 in the machine code program component 204A, can be loaded into and thereby associated with respective processor memory locations by the loader/linker 406 interoperating with the MMS 410. Executable addressable entities, such as the addressable entity 408, include one or more machine code instructions, such as the machine code instruction 206, which can be associated with processor memory locations when the addressable entity 408 is loaded into the processor memory 210. Examples (a non-exhaustive list) of executable addressable entities include functions, subroutines, methods associated with classes, labeled machine code instructions that can be the target of “jump” or “goto” machine code instructions, and anonymous addressable entities such as a “while” loop.

Referring again to FIG. 2, a joinpoint can be associated with a processor memory location of a machine code instruction based on a pointcut specification, thereby making the machine code instruction a JPI. The association can be made via associating aspect information with the JPI 206. Additional processing related to the joinpoint can be performed when an access to the JPI 206 by the processor 208 is detected. The additional processing can be based on the associated aspect information as is described below.

The aspect binder 202 can be configured for identifying a joinpoint included in a machine code program component 204 in correspondence with loading, linking, or executing the machine code program component including the joinpoint. Analogously, as described in more detail below, the aspect binder 202 can be configured for identifying an advice operation in correspondence with loading, linking, and/or executing the machine code program component 204B including the advice operation. Example joinpoint identification times include load and/or link time of a portion of a machine code program component 204, run-time instantiation and/or deletion time of an instance of an addressable entity, and execution time of an addressable entity. Additionally, as discussed below joinpoint identification based on a pointcut specification can be further based on attribute information available at the time of determination.

Generating, storing, and accessing attribute information for joinpoint identification can be accomplished in any number of ways. Further when a joinpoint is identified, an arrangement of components can be configured for associating or binding an identified joinpoint and/or a potential joinpoint with a processor memory location associated with a JPI in a direct manner or in an indirect manner. The terms “direct” and “tight” are used interchangeably in the context of binding a JPI to a processor memory location and/or aspect information. The terms “indirect” and “loose” are used interchangeably in this same context. Examples of different joinpoint identification times with loose and tight binding of a joinpoint with a processor memory location associated with the JPI 206 are described below.

With respect to metadata management, in generating and loading of the machine code program component 204A based on the source code 502, build tools can be configured for creating a symbol table and a memory map. Metadata available and saved during the generation of loaded and linked machine code includes a subset of attributes upon which a pointcut specification can be based. An attribute usable in a pointcut specification and thus in joinpoint identification operation can be any information available within an execution environment 402 to an aspect binder 202 operating in the execution environment as described above. Example attributes (a non-exhaustive list) include the virtual or physical processor memory address of the machine code instruction, the machine code instruction itself, an operand of the machine code instruction, a data type of an operand of the machine code instruction, information associated with a runtime process in which the machine code instruction is accessed, a symbol or name associated with the machine code instruction, a data type associated with a processor memory location accessed by the machine code instruction, an attribute of an invoker of the machine code instruction, an attribute of a “user” with access privileges to the machine code instruction, information associated with an addressable entity that includes the machine code instruction, and information associated with a machine code program component 204 to which the addressable entity including the machine code instruction belongs. The aspect binder 202 can be configured for identifying a joinpoint based on whether available attribute information satisfies or matches a pointcut specification.

One or more operations can be performed in identifying a joinpoint in a machine code program component 204. For example, identifying a joinpoint can include a first identifying operation for identifying a potential joinpoint and a second identifying operation for identifying the potential joinpoint is a joinpoint. A pointcut specification can include a matching criterion associated with an attribute that is testable only at specific times in the processing and/or executing of a portion of a machine code program component 204. If the aspect binder 202 performs an operation for identifying a joinpoint at a time when the matching criterion included in the pointcut specification can be tested, then the aspect binder 202 can determine whether the attribute or attributes match the matching criterion. The aspect binder 202 can identify a joinpoint in the machine code program component 204A based on the pointcut specification and the available attributes. In such cases a JPI can be identified when a match is detected.

When at least a portion of a matching criterion is based on an attribute that is not available when the aspect binder 202 performs a determination operation, the aspect binder 202 can be configured for determining whether a remainder of the matching criterion, based on an available attribute or attributes, matches a portion of the pointcut specification. When the determination indicates no match, there is no joinpoint. If there is a match, a potential JPI 206 can be identified. The potential JPI 206 can be further tested when an attribute for the untested portion of the matching criterion is available. Identifying a potential joinpoint early in the processing of a machine code program component 204A can provide performance benefits. For example, a determination can be made on the loadable object code 508 prior to or during loading of the loadable object code 508 into the processor memory 210. The number of joinpoint identification operations performed during execution can be reduced by eliminating from consideration addressable entities and locations where no joinpoint can exist based on a pointcut specification. Further, in a portion of the machine code program component 204A where a joinpoint is identified, the aspect binder 202 can be configured for not performing another determination operation for the portion. Alternatively or additionally, in a portion where a determination operation determines neither a joinpoint nor a potential joinpoint exits, the aspect binder 202 can be configured for not performing another determination operation on the portion. Alternatively, in a portion where a first determination operation determines a potential joinpoint, the aspect binder 202 can be configured for performing a second determination operation for identifying whether the potential joinpoint is a joinpoint. Any portion of a machine code program component 204A for which the aspect binder 202 has not performed a determination operation can be considered to include a potential joinpoint.

Referring again to FIG. 4, a joinpoint can be associated with a processor memory 210 location of the JPI 206 by providing for mediating an access to the processor memory location by a component for joinpoint processing associated with the access. For example, the MMS 410 can be configured for mediating access to the addressable entity 408 including the JPI 206. Depending on the processor memory location of the JPI 206 included in the addressable entity 408, the MMS 410 can invoke a component in the role of an access detector 212 at a point before, during, and/or after the execution of the JPI 206 and/or the addressable entity 408 accessed by the processor 208.

Alternatively or additionally, a joinpoint can be associated with a processor memory location by modifying the processor memory location providing for an access detector 212 to be invoked. For example, the loader/linker 406 and/or the aspect binder 202 can be configured for replacing a machine code instruction stored in the associated processor memory location with a software interrupt machine code instruction. An appropriate access detector 212 for the aspect specification can be configured as an interrupt handler for the interrupt machine code instruction. The replaced machine code instruction can be saved and executed in correspondence with the processing of the interrupt machine code instruction by the configured access detector 212. Alternatively, the aspect binder 202 can be configured for activating a hardware interrupt such that an access to the processor memory location associated with the JPI 206 generates the hardware interrupt associated with an appropriate access detector 212 configured as an interrupt handler for the activated hardware interrupt. In another alternative, the processor memory 210 including the location of the associated JPI 206 can be marked. Marked processor memory creates a loose coupling between a joinpoint and a JPI. A hardware and/or software access detector 212 can be configured for detecting an access to a marked portion of processor memory.

The loader/linker 406 can be configured for interoperating with the MMS 410 configured for identifying a joinpoint at the time of loading and/or linking the addressable entity 408 into the processor memory 210. The loader/linker 406 can be configured for determining attribute information associated with a machine code instruction, such as the machine code instruction 206, and/or an including addressable entity 408 when loading at least a portion of a machine code program component 204A including an addressable entity, such as the addressable entity 408, into the processor memory 210. The loader/linker 406, as indicated, can be configured for interoperating with the MMS 410 to determine a processor memory location for storing the machine code instruction 206.

During, before, and/or after loading the addressable entity 408 the MMS 410 and/or the loader/linker 406 can be configured for notifying the aspect binder 202 that the addressable entity is or has been loaded or linked. The aspect binder 202 can be configured for receiving an aspect specification, such as the aspect specification 302A. The aspect specification can be received via a graphical user interface (GUI) 414 configured for receiving information for creating, editing, and deleting some or all of the specification. As described above, various schemas, notations, and language types are suitable for providing a pointcut specification and/or an associated advice specification that is not specific to a particular programming language. Regardless of a schema or language type for defining pointcut and/or advice specifications, a user interface, such as the aspect configuration graphical user interface (GUI) 414 can be configured for receiving user input for building a pointcut and/or advice specification. The aspect configuration GUI 414 can be configured for hiding a schema and specification language in which pointcut and/or advice specifications are defined by a user. Alternatively, the aspect configuration GUI 414 can be configured for receiving pointcut and/or advice language and schema specific information from a user with knowledge of a pointcut and/or advice language supported by a particular arrangement.

An aspect configuration specification such as depicted in FIG. 3 can be generated manually by a user such as a developer and/or a user of a machine code program component 204. Symbol information can be provided by a user in comments in the source code 502 and associated with symbols in the symbol table generated by the compiler 504, loader/linker 406. Alternatively, a tool such as the compiler 504, loader/linker 406 can be configured for mapping a programming language specific symbol space to a language neutral symbol space defined for identifying program addressable entities in a language neutral manner. Further, symbols in the symbol space of the compiler 504 or interpreter of the programming language used for the source code 502 can be provided by a user for ease of use. Programming language specific symbols along with language neutral symbols can be used in generating the aspect specification 302B and/or an aspect specification template.

Another example specification language can be based on SOAP. SOAP was designed for remote procedure call (RPC), thus allowing addressable entities to be specified and invoked via remote procedure call (RPC) in a language neutral manner based on the SOAP schema(s). The SOAP schema(s) can be extended to define aspect information elements allowing specification of aspect information in association with the specification of addressable entities. Alternatively, SOAP elements can be used in conjunction with XML elements specified by a schema for defining aspect information and matching criterion elements using the namespace capabilities of XML. Resource definition framework (RDF) is another existing XML specification language that can be extended or used with a second schema as just described for specifying aspect information and matching criterion for associating specified aspect information with a machine code instruction 206 included in a machine code program component 204.

Alternative means for receiving an aspect specification include receiving via a network from another device (not shown), via a file import facility, and/or via the loader/linker 406 when the aspect specification is provided with loadable object code 508. The aspect binder 202 can be configured for storing aspect information based on an aspect specification in an aspect specification database 416.

When at least a portion of loadable object code 508, such as the addressable entity 408, is loaded and linked, the aspect binder 202 can be configured for retrieving at least the pointcut specification portion of an aspect specification record. The aspect binder 202 can be further configured for querying the MMS 410 for retrieving attribute information for processing the pointcut specification. The aspect binder 202 can determine whether a joinpoint is in the loaded and/or linked portion of the first machine code program component 204A based on the information retrieved by the querying operation.

A loader/linker 406 interoperating with an SDSS based MMS 410 can be configured for storing metadata associated with the first machine code program component 204A, at least a portion of its addressable entities, and/or at least a portion of its machine code instructions as instructed by commands in the loadable object code. An SDSS based MMS 410 can be configured for including some or all the information that can be included in a memory map and in a symbol table. An SDSS based MMS 410 can be configured so that any information can be stored and accessed easily. An SDSS based MMS 410, in this sense, can include much more than memory map and symbol table information. For example, an SDSS can store addressable entities and instances of addressable entities in tables. The table names, column names, column data types, constraints, and references among tables can provide the aspect binder 202 with metadata including names of addressable entities, data types of parameters, variables, and return values, and scope information.

The aspect binder 202 can be configured for retrieving a pointcut specification from the aspect specification database 416 for determining whether the addressable entity 408 and/or the first machine code program component 204A include a joinpoint. The aspect binder 202 can be configured for retrieving metadata as attribute information associated with a portion of the first machine code addressable entity 204A from the MMS 410. The aspect binder 202 can generate a query based on the retrieved metadata. The aspect binder 202 can submit the query to the aspect specification database 416 for locating a pointcut specification that at least partially matches the attributes from the MMS 410. Alternatively, the aspect binder 202 can be configured for retrieving a pointcut specification from the aspect specification database 416. The aspect binder 202 can be configured for generating a query based on the pointcut specification. The aspect binder 202 can provide the query to the MMS 410. The MMS 410 can be configured for locating an addressable entity that at least partially matches the matching criterion or criteria in the pointcut specification.

The aspect binder 202 can be configured for processing the pointcut specification defined by the <pointcut> element 304 in FIG. 3, based on an associated pointcut schema. The pointcut specification 304 indicates that a matching joinpoint is included in the first machine code program component 204A as indicated by the <component> element 308A. The aspect binder 202 can further determine that a matching joinpoint is included in an addressable entity associated with a symbol, “dolt,” from the system namespace as indicated by the <symbol> element 310A . Based on the <symbol> element 314 included in the <aentity> element 312A and the schema, the aspect binder 202 can further identify a joinpoint in an instance of the “dolt” addressable entity when the instance invokes an addressable entity associated with the symbol “error” from the “common” namespace. The loader/linker 406 can be configured for generating a runtime memory map and symbol table based on a memory map and symbol table associated with the loadable object code 508. The loadable object code 508 memory map and symbol table can be generated by the build tools to include language specific symbols for the “dolt” and the “error” addressable entities. The “common” namespace symbol “dolt” can be configured by a user via the GUI 414 or can be generated automatically by one of the build tools as can the “common” namespace symbol “error”.

An example pseudo-source code from which the addressable entity 408 can be generated is included below.

```
int dolt(int y) {
        static int x = 5;
        x = addlt(y,x);
        return x;
}
int addlt(int a, int b) {
        if (a > b) then error(−1);
        return (a+b);
}
```

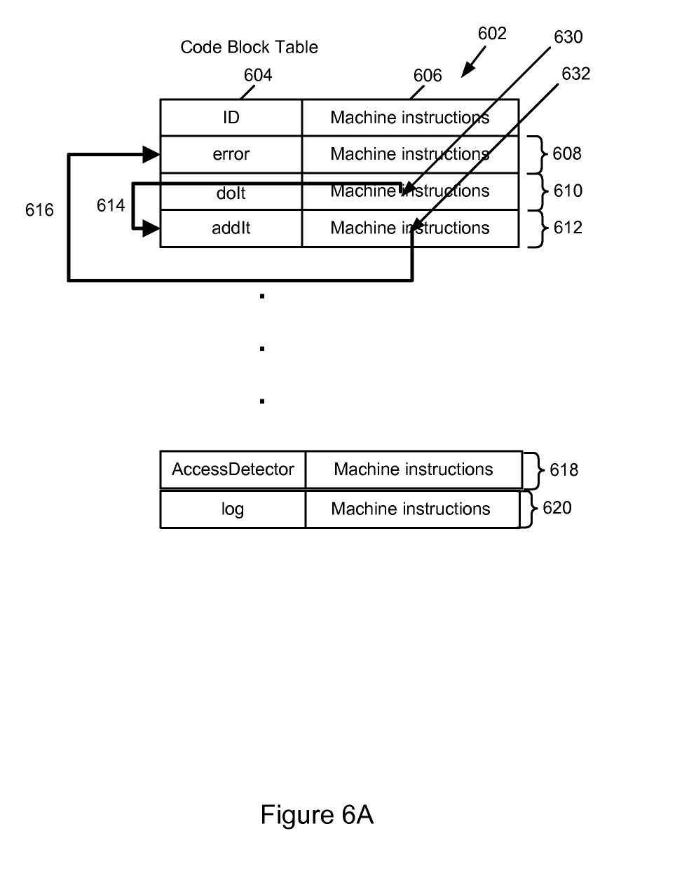

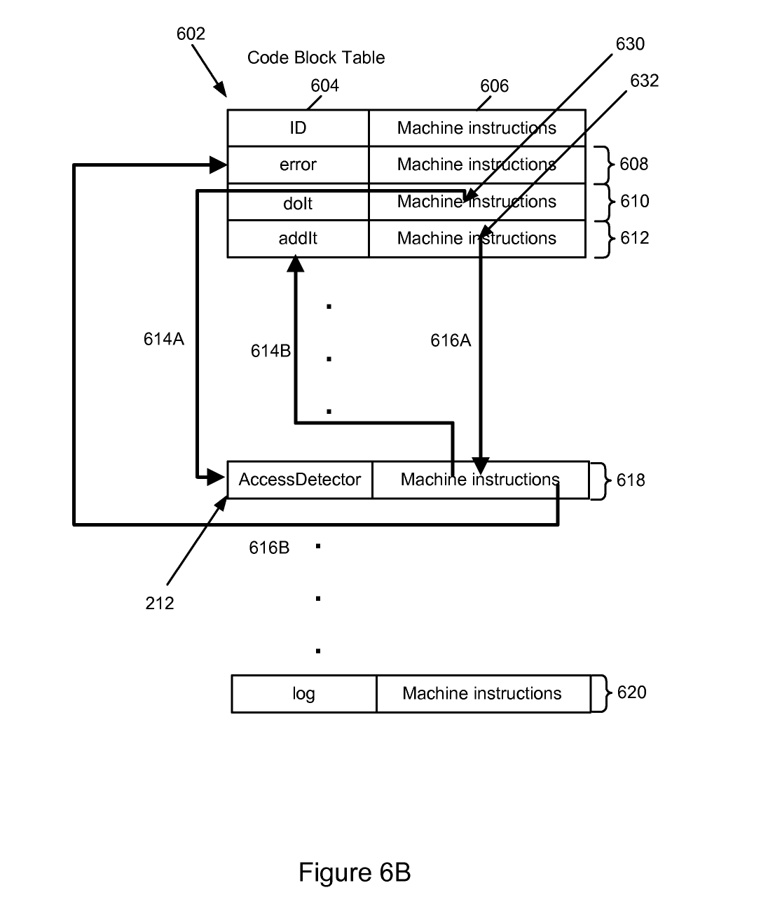

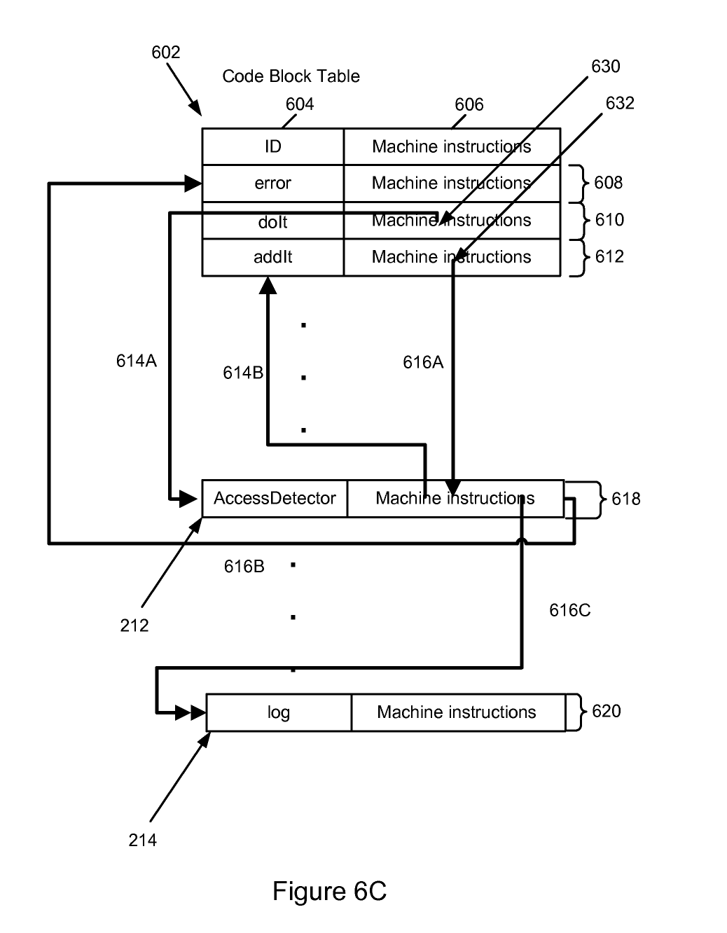

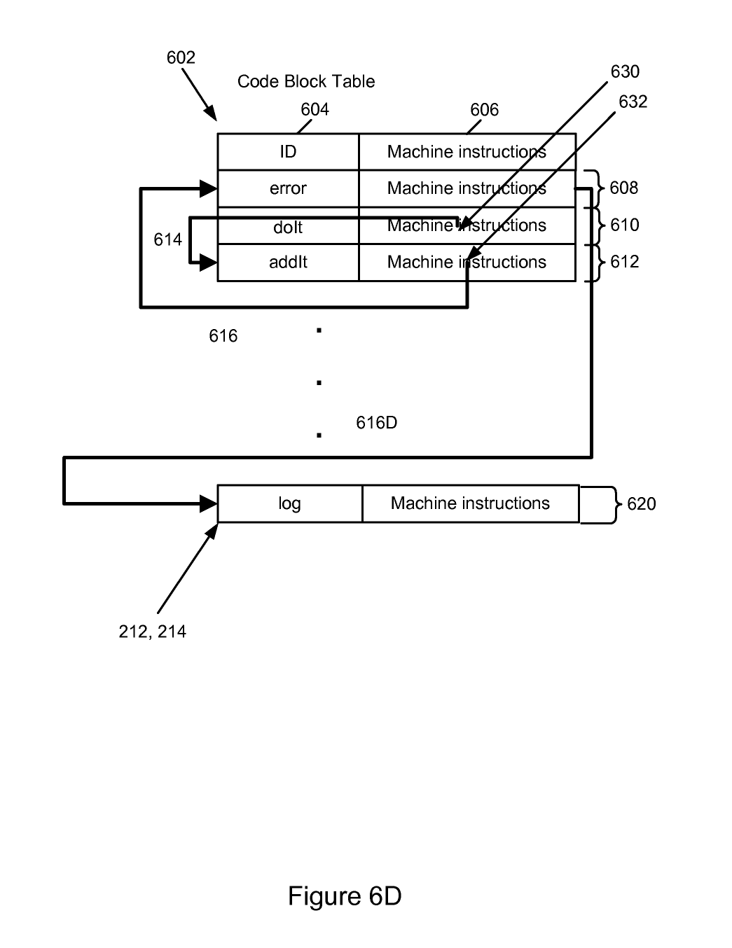

A source code “dolt” representation is included that calls an “addlt” function. The “addlt” function calls an “error” function. FIG. 6A depicts a code block table 602 for storing machine code instructions included in the first machine code program component 204 for execution by the processor 208 according to an SDSS based MMS 410.

Referring now to FIG. 6A, an exemplary code block table 602 includes an ID column 604 for storing an identifier for the machine code of an addressable entity and a machine code column 606 for storing the machine code instructions of various addressable entities. Depicted in the code block table 602 are a “dolt” record 608 for storing the machine code instructions of the “dolt” addressable entity 408, an “addlt” record 610 for an “addlt” addressable entity, and an “error” record 612 for an “error” addressable entity called by the “addlt” code block. A machine code instruction in the “dolt” addressable entity 408 for invoking the “addlt” addressable entity is depicted as a link 614 from the machine code in the “dolt” record 608 to the “addlt” record 610. Similarly, a link 616 from the machine code in the “addlt” record 610 to the “error” record 612 can be provided by the loader/linker 406 for a machine code instruction in the “addlt” machine code for invoking the “error” addressable entity.

At load/link time, the aspect binder 202 can be configured for determining that a machine code instruction at a processor memory location 630, is associated with the machine code instruction in the “addlt” addressable entity for invoking the “error” addressable entity, and for determining another machine code instruction at a processor memory location 632 in the “dolt” addressable entity 408 for invoking the “addlt” addressable entity”, as depicted by the link 614 and the link 616. The aspect binder 202 can bind a processor memory location of the JPI 206 with the identified joinpoint. The aspect binder 202 can determine a processor memory location including the JPI 206 to associate with the joinpoint and/or potential joinpoint. The aspect binder 202 can be configured for selecting a JPI from a plurality of alternative JPI's. In the example, the aspect binder 202 selects a machine code instruction of an identified potential joinpoint. For example, the selected potential JPI 206 can be the machine code instruction at the location 630 in the “dolt” record 610 including an address indicated by the link 614 associated with the “addlt” code block record 612 for invoking the “addlt” addressable entity. At this point in executing an instance of the “dolt” addressable entity, it is not known whether an instance of the “error” address entity will be invoked. Determination of an actual joinpoint can be performed at execution time of an instance of the “dolt” addressable entity 408. The aspect binder 202 can be configured for placing a component performing the role of an access detector 212 for completing the determination at execution time at a point in execution associated with the selected potential JPI 206 associated with the location 630. A code block record 618 of the access detector 212 is located by the MMS 410 as directed by the aspect binder 202.

FIG. 6B depicts the exemplary code block table 602 after the aspect binder 202 has associated the processor memory location 630 of the potential JPI 206. The aspect binder 202 can be configured for interoperating with the SDSS based MMS 410 to replace the address in the machine code invocation instruction in the “dolt” addressable entity 408 for invoking the “addlt” addressable entity with the address of the access detector 212 in record 618. The access detector 212 in record 618 can be configured to receive the parameters intended for the “addlt” addressable entity, store an indication of the intercepted call including context information such as the thread or process ID, and invoke the “addlt” addressable entity providing the intended parameters when the processor 208 accesses the modified instruction. This change is indicated by the links 614A and 614B illustrated in FIG. 6B.

The aspect binder 202 can be further configured for interoperating with the SDSS based MMS 410 to replace the address in the machine code invocation instruction at the location 632 in the “addlt” addressable entity for invoking the “error” addressable entity with an address of a second entry point in the access detector 212 in record 618. This change is indicated by the link 616A and 616B in FIG. 6B. Alternatively, a second access detector or a second instance of the access detector 618 can be provided for detecting an access to machine code instruction associated with the location 632. When the processor 208 accesses the modified instruction in the “addlt” machine code, the access detector 212 is invoked at the second entry point stored in the code block table 602 record 618. The access detector 212 can be configured for determining whether a previous invocation of the access detector 212 occurred based on a stored indication and context information. If the indication is negative, the access detector invokes the “error” addressable entity in record 608 as indicated by the link 616B. If the indication is positive, the potential JPI 206 is confirmed as an actual JPI 206. Based on the confirmation, the access detector 212 provides for clearing the indication and invoking an advice operation described with respect to FIG. 6C below.

When the access detector 212 invokes the “addlt” addressable entity via link 614B, the access detector 212 can be configured for being included in the return path. When the “addlt” addressable entity returns, the access detector 212 regains processor control and can be configured to clear the indicator. Thus, an access by the processor 208 of the potential JPI 206 associated with the location 630 (the instruction for invoking the “addlt” addressable entity) is detected by the access detector 212. The links illustrated in FIGS. 6A and 6B can be static links and/or dynamic links based on the characteristics of the execution environment 402 and the hosted components described. Thus, the “error” addressable entity can be invoked as originally intended.

The access detector 212 in FIG. 6B in record 618 is depicted as a single code block, such as a function or a method call for convenience. In an alternative embodiment, the access detector 212 can include several code block records each corresponding to an invocation by a modified invocation instruction in the “dolt” and/or “addlt” addressable entities. The access detector 212 described can follow a pattern. The particular pattern described that intercepts an invocation for a specified addressable entity from an addressable entity modified for invoking the access detector 212, provides an indication that an access has been detected along with necessary context information, invokes the intended addressable entity, determines whether an invocation of a second specified addressable entity is made in the same context based on the stored indication and context information, performs an advice operation if the determination is positive, invokes the intended second addressable entity, and ensures the indication is clear on return. A code template can be used by the aspect binder 202 for generating an access detector 212 and associating the access detector with the JPI 206. This is one of many exemplary patterns that can be specified in a template for generating access detectors 212 for use in various identifiable situations.

Alternatively, the aspect binder 202 can be configured for establishing an access detector 212 to be invoked for all calls to the “error” addressable entity. An aspect binder 202 interoperating with an SDSS based MMS 410 can be configured for providing an access detector record with the record ID of the error record and for providing a link causing the execution of the machine code in the access detector record to call machine code in the error code block record. The access detector 212 can be configured for determining, based on the call chain, that the criterion in the pointcut specification 304 is met, thus identifying a joinpoint including a JPI. In yet another alternative, the aspect binder 202 can be configured for instructing the MMS 410 to establish an access detector 212 to intercept all calls to the “addlt” addressable entity.

In each alternative, the access detector 212 is generated from a different template based on identified pattern suitable for a selected JPI 206. For example, when the aspect binder 202 can determine that the “error” addressable entity is only invoked by the “addlt” addressable entity based on scope information and symbol reference information, the aspect binder 202 can identify a joinpoint prior to execution of the “dolt”, “addlt”, and “error” addressable entities. The aspect binder 202 can be configured for providing an access detector 212 for intercepting all invocations of the “error” addressable entity. The access detector 212 can be configured for performing an associated advice operation as described below. No further joinpoint identification operations are required in such an embodiment. Any access to the error addressable entity is a joinpoint. Thus, the access detector 212 can be configured for identifying an advice operation 214 or for invoking an advice operation 214 already identified as is described below.

The MMS 410 can be configured for establishing the various alternative JPI's and associated access detectors 212 via additional columns included in the code block table 602, another table, and/or via a new table. The aspect binder 202 can be configured for indicating an association between an identified joinpoint with a processor memory location of an associated JPI 206 by modifying a new column. This technique can be used as an alternative or in addition to modifying machine code as described above.

The access detectors 212 in the various alternatives described above can be configured for being processed prior to; during using a separate thread, process, and/or processor; and/or after processing of the JPI 206 depending on the pointcut specification, the execution environment 402, and the configuration of the aspect binder 202.

According to an aspect, an arrangement can be configured for identifying a joinpoint in a machine code program component 204A based on an aspect specification only at execution time of a portion of the machine code program component 204A. For example, the processor 208 can be configured for generating an interrupt for each processor memory access of a machine code instruction and/or an addressable entity included in the machine code program component 204A. The interrupt handler or access detector 212 can be configured for performing the role of the aspect binder 202 or to interoperate with a separate aspect binder 202 to determine whether an access is associated with a joinpoint or potential joinpoint. An arrangement configured as such can include a conventional MMS 410 configured for providing access to memory map and symbol table information and/or can include an SDSS based MMS 410 for joinpoint determination. Alternative arrangements using memory map and symbol table information are described below.

Returning to FIG. 1, in block 104 an advice operation included in a machine code program component is identified based on an advice specification included in the aspect specification. Accordingly, a system for invoking an advice operation associated with a joinpoint includes means for identifying, based on an advice specification included in the aspect specification, an advice operation included in a machine code program component. For example, as illustrated in FIG. 2, the access binder component 202 is configured for identifying, based on an advice specification included in the aspect specification, an advice operation included in a machine code program component.

Referring again to FIG. 3, an exemplary advice specification bounded by an <advice> element 316A can be included in the <aspect> element 302A associating the included <pointcut> element 304A with the advice information in the <advice> element 316A. The <advice> element 316A specifies a criterion for identifying an advice operation 214 included in a machine code program component 204. The identifying of an advice operation 214 based on an advice specification can be performed in a manner analogous to the alternatives described above for identifying a joinpoint in a machine code program component 204. The advice specifications 316A and 316B are based on an XML markup language defined by a schema for configuring advice specifications. The aspect binder 202 can be configured for receiving, providing for storing and validating that the advice specifications 316 conform to the schema for advice specifications.

The aspect binder 202 is configured for identifying an advice operation 214 in machine code program component 204 based on the advice specification 316 associated with a joinpoint determined based on the respective pointcut specification 304. A machine code program component 204, such as a second machine code program component 204B in FIG. 2, can be generated from source code written in any of a plurality of programming languages. An advice operation 214 can be included in the same machine code program component 204 as its associated joinpoint, or the advice operation 214 can be included in different machine code program component 204 than its associated joinpoint. Additionally, the machine code program component 204 including the advice operation 214 can be generated from source code written in a programming language that is different from the programming language of the source code from which the machine code program component 204 including the joinpoint is generated.

When the aspect binder 202 identifies the JPI 206, the aspect binder 202 can attempt to determine an advice operation 214 based on the advice specification specified by, for example, the contents of the <advice> element 316A. As with the pointcut specification, an advice specification can include a matching criterion based on any attribute accessible to the aspect binder 202 during advice operation identification. The available attributes can be restricted by the schema configured for defining the structure and content of a valid advice specification for identifying an advice operation 214 associated with a joinpoint included in a machine code program component 204. The advice specification includes information for identifying machine code for performing an advice operation 214. For example, the advice specification can include a matching criterion based on an attribute of an addressable entity, an attribute of a relationship between or among a plurality of addressable entities, an execution environment attribute, and a conditional test.

The aspect binder 202 can associate the identified advice operation 214 with the identified JPI 206 via an access detector 212 at the time of joinpoint identification prior to an access to the machine code instruction determined to be the JPI 206 by the processor 208 for executing. Examples of joinpoint identification by the aspect binder 202 at load and/or link time are described above. When an advice operation 214 is configured for being an access detector 212 associated with the JPI 206, the access detector is a “joinpoint” access detector 212 as defined below. Alternatively, an aspect binder 202 can be configured for identifying an advice operation 214 based on an advice specification associated with a pointcut specification only after an access by the processor 208 to the associated JPI 206 is detected by the associated access detector 212.

In FIG. 4, the aspect binder 202 is configured for interoperating with the MMS 410 for identifying an advice operation 214 associated with the identified joinpoint associated with the processor memory location of the JPI 206. The MMS 410 an be configured for determining attribute information associated with a machine code instruction, such as the machine code instruction 206, and/or an addressable entity 408 when loading the addressable entity 408 into the processor memory 210.

An advice specification can, like a pointcut specification, include a value attribute including an acceptable value of an addressable entity, a scope attribute identifying a portion of the executable program component wherein the addressable entity is known, and a symbol attribute including an identifier of the addressable entity.

The aspect binder 202 can determine an advice operation 214 based on the content of the <advice> element 316A in FIG. 3. The <advice> element 316A can include an <aentity> element 318A for identifying one or more addressable entities that can include an advice operation 214. In the <aentity> element 318A, a <component> element 320A can include content for identifying one or more machine code program components 204 that can include an advice operation 214. In FIG. 3, the content identifies a “utilities.dll” loadable object code file associated with a second machine code program component 204B in FIG. 2. The aspect binder 202 can be configured for interoperating with one or more of the loader/linker 406, the operating system 404, or other component in the execution environment 402 such as a file subsystem to associate the string in the content of the <component> element 320A with the second machine code program component 204A loaded into the processor memory 210. Alternatively, an SDSS based MMS 410 can include component identifiers as structured processor memory metadata, for example as table metadata associated with code block instance tables (not shown) associated with records in the code block table 602 in FIG. 6A-D.

A <symbol> element 322A can be provided for identifying one or more locations in the second machine code program component 204B that can be an advice operation 214. The exemplary <symbol> element 322A specifies a matching criterion based on a symbol associated with an addressable entity. The symbol “log” from the “common” namespace is provided as a matching criterion. Advice operations 214 are executed, so by default a matching location includes executable data. In an SDSS based MMS 410 associated with FIGS. 6A and 6B, symbols including alias symbols from a shared name space can be used as keys in the ID column 604 of the code block table 602. Additionally, the table 602 can include an additional column (not shown) identifying the associated machine code program component 204.

Two <param> elements 324A are illustrated in the <symbol> element 322A for specifying a call signature for a matching advice operation 214. The parameters also indicate parameters accepted by the advice operation 214 when performed. The “%instance%” variable can be defined by an associated schema to indicate that instance variables of the associated joinpoint addressable entity are accepted by the advice operation 214. The format for providing this information can be predetermined or preconfigured for the aspect binder 202 and/or various access detectors 212 providing for proper formatting when calling the advice operation 214. The exemplary string “TID, C, S, P, R” includes predefined symbols for the second parameter specified by the advice specification schema indicating further information to be provided. In the example <param> element 324A, “TID” indicates the thread ID and/or process ID of an accessed JPI 206. “C” indicates a component identifier of the machine code program component 204A including the accessed JPI 206. “S” indicates a symbol for the addressable entity 408 including the JPI 206. “P” indicates parameter names and values of the addressable entity 408. “R” indicates a return value of the addressable entity, if one exists.

A schema provider can use other markup language based formats, command language formats, and other reserved symbols and syntax. Since machine code program component identifiers are known prior to load time and addressable entity symbols are known no later than link time, the advice operation 214 can be determined prior to execution of either of the first machine code program component 204A or the second machine code program component 204B. Thus, the aspect binder 202 can be configured for providing a reference to the advice operation 214 to the access detector 212 associated with the JPI 206.

In an SDSS based MMS 214 the code block instance table (not shown) associated with the “log” record 620 in FIGS. 6A and 6B can provide column names, types, and constraints that the aspect binder 202 can match against the advice specification represented by the <advice> element 316A including the <param> element 324A.

FIG. 6C illustrates an exemplary modification to the code block table 602 by the SDSS based MMS 410 as instructed by the aspect binder 202 in response to determining the “log” executable entity stored in the record 620 as the advice operation 214 matching the criterion included in the advice specification represented by the <advice> element 316A. In FIG. 6C, the access detector 212 established in record 618 can be configured for including a machine code instruction for invoking the “log” advice operation 214 machine code stored in the code block table 602 in the record 620 via a link 616C established by the aspect binder 202 and/or the access detector 212. The double arrow end depicted on the link 616C indicates the “log” advice operation 214 machine code in the record 620 can be invoked via an asynchronous invocation. The asynchronous link 616C is consistent with the “parallel” value in the “association” attribute of the <execute> element in the advice specification specified by the <advice> element 316A.

FIG. 6D illustrates an exemplary modification to the code block table 602 by the SDSS based MMS 410 as instructed by the aspect binder 202 in response to determining the “log” executable entity stored in the record 620 as the advice operation 214 matching the criterion included in the advice specification represented by the <advice> element 316A. In FIG. 6D, the advice operation 214 can be configured for being the access detector 212 established in record 620. The advice operation 214 is a “joinpoint” access detector 212 as defined below. This setup by the aspect binder 202 interoperating with the SDSS based MMS 410 can be appropriate for an advice operation 214 when the advice operation 214 can be determined at joinpoint identification time, and joinpoint identification time occurs prior to an access of the identified JPI 206 by the processor 208 for executing. The links 616 and 614 remain as in FIG. 6A. The <execute> element 326A indicates that the advice operation 214 can be invoked after the execution of the JPI 206 by the processor 208. The link 616D can be established in the machine code record 608 of the “error” addressable entity for invocation of the “log” advice operation 214 near the end of or after the execution of the “error” addressable entity. The link 616D can be established by modifying the machine code in the record 608. Alternatively, the advice operation 214 can be configured for intercepting invocations of the “error” addressable entity 608. This places the “log” addressable entity in the return path allowing the “log” addressable entity to perform its operation when the “error” addressable entity returns control to the “log” addressable entity. In a further alternative, the link 616D can be stored in a separate column (not shown) of the record 608. Access to a JPI and corresponding operation of associated access detectors 212 are described in more detail below.

If allowed by an associated advice schema, an advice specification conforming to the schema can included attributes accessible only in correspondence with an access or attempted access of the JPI 206 by the processor 208 for executing the JPI 206. In such a case, an access detector 212 associated with the JPI 206 can be configured for identifying the advice operation 214 when the access detector 212 is executed. Alternatively, if the advice specification is based on an attribute available prior to an access of the JPI 206 and an attribute available only at the time of access, execution, and/or after execution of the JPI 206, and access detector 212 can be established that executes based on the attribute information determined prior to an access of the JPI 206. For example, an advice specification can include an identifier of a machine code program component 204 including an advice operation 214. The advice specification can include a conditional expression specifying one of a plurality of advice operations 214 selected for performing based on an evaluation of the conditional expression at the time of access, during execution of, or just after execution of the JPI 206. An access detector 212 can be established that restricts its determination operation to the identified machine code program component 204.

The advice operations 214 in the various alternatives described can be configured for being processed prior to; during using a separate thread and/or process, and/or processor; and/or after processing the JPI 206 depending on the pointcut specification, the advice specification, the execution environment 402, and the configuration of the aspect binder 202.

Returning to FIG. 1, in block 106 an access to the machine code instruction in the joinpoint for execution by a processor is detected. Accordingly, a system for invoking an advice operation associated with a joinpoint includes means for detecting an access to the machine code instruction in the joinpoint for execution by a processor. For example, as illustrated in FIG. 2, an access detector component 212 is configured for detecting an access to the machine code instruction in the joinpoint for execution by a processor 208.

“Access” as it is used with respect to a memory location includes the operations of reading from and writing to a memory location. Operations that read to and/or write from a memory location include loading and storing data into and from, respectively, a processor register, and copying content from a first memory location to a second memory location. Processing the contents of a memory location includes reading a machine code instruction from the memory location, so an execution access can be viewed as a type of read access. Detecting an access to a JPI includes any detected indication that an access to a memory location for execution of the JPI will occur, is occurring, and/or has occurred.

As described above, the aspect binder 202 can be configured for identifying a joinpoint and associating the JPI 206 with the joinpoint. The aspect binder 202 can be configured for establishing the association by configuring the access detector 212 to be executed in correspondence with an access of the JPI 206 by the processor 208 for executing. The time an advice operation is identified can depend on a type of access detector associated with an associated joinpoint or potential joinpoint. The access detector 212 can be a “generic”, a “joinpoint”, or a “pointcut” access detector 212 as described below.

A “generic” access detector 212 is configured with no information specific to the JPI 206. As a result, a “generic” access detector 212 is configured for locating an aspect specification record that matches one or more attributes available in correspondence with an access by the processor of a machine code instruction 206. The access detector 212 so configured, in effect, re-determines or confirms a machine code instruction is a JPI associated with a joinpoint. A “generic” access detector 212 associated with a potential JPI can determine whether the potential JPI is, in fact, a JPI, in correspondence with an access by the processor 208. The access detector 212 can be configured for performing joinpoint confirmation and/or determination with or without interoperating with the aspect binder 202. When the “generic” access detector 212 confirms a joinpoint and/or determines a potential joinpoint is a joinpoint, an advice specification associated with the pointcut specification is identified by the aspect binder component 202, and/or an advice operation is performed.

A “joinpoint” access detector 212 can be configured for either invoking an advice operation 214 or for performing the advice operation 214 determined based on the advice specification associated with the pointcut specification. When a joinpoint can be determined by the aspect binder 202 at load/link time and an advice operation can be determined at load/link time, a “joinpoint” access detector 212 can be configured for performing the determined advice operation 214 and associated with the JPI 206. Alternatively, a “joinpoint” access detector 212 can be configured with access to the associated advice specification.

When a potential JPI is determined by the aspect binder 202 based on a partial match of a pointcut specification, a “pointcut” access detector 212 can be associated with the potential JPI. A “pointcut” access detector 212 is configured with at least a portion of the partially matched pointcut specification or a reference to the partially matched pointcut specification. A “pointcut” access detector 212 does not have to locate a pointcut specification as a “generic” access detector does. Rather, a “pointcut” access detector 212 can be configured for determining whether the potential joinpoint is an actual joinpoint based on the pointcut specification included in the provided partially matched pointcut specification. If the access detector 212 determines an actual joinpoint, then an advice operation 214 is identified based on the advice specification associated with the pointcut specification. In an alternative, at the time the aspect binder 202 determines the potential JPI, the aspect binder 202 can predetermine the advice operation 214 matching the associated advice specification if the attributes are available. Predetermination of the advice operation 214 can provide a performance advantage, since the advice operation 214 is determined once rather than each time the “pointcut” access detector 212 determines an actual joinpoint based on the pointcut specification associated with the access detector 212.

In some cases, a “pointcut” access detector 212 associated with a potential JPI can determine that the potential JPI is a JPI and will always be a JPI. In these cases, the “pointcut” access detector 212 can be configured for providing for associating a “joinpoint” access detector 212 with the determined JPI 206. The “pointcut” access detector 212 can invoke the aspect binder 202 for performing the re-association. Analogously, a “generic” access detector 212 can determine that a machine code instruction is a potential JPI or a JPI and that the determination will remain stable for future detected accesses by the processor 208. In these cases, the “generic” access detector 212 can be configured for providing for associating a “pointcut” or a “joinpoint” access detector 212, respectively, with the determined potential JPI 206. The “generic” access detector 212 can invoke the aspect binder 202 for performing the re-association. All three types of access detectors 212 can be configured for at least one of identifying a joinpoint and identifying an advice operation in response to detecting an access to a machine code instruction.

As described above, when a joinpoint and/or a potential joinpoint are determined, a processor memory location associated with a JPI and/or potential JPI can be associated with the determined joinpoint and/or potential joinpoint. A joinpoint and/or a potential joinpoint can be associated with a processor memory location of an associated JPI 206 in a number of ways. Thus, detecting an access to a machine code instruction associated with a joinpoint can be performed by, for example, a MMS, a software access detector, a hardware access detector, a configured interrupt handler, the aspect binder 202, and or an advice operation associated with the joinpoint as described above.

For example, as illustrated in FIG. 2 and described above, the aspect binder 202 provides for an access detector 212 to be invoked in correspondence with an access by the processor 208 of the processor memory location associated with the determined JPI 206. The invocation of an access detector 212 indicates an access to the machine code instruction, such as the JPI 206. The access detector 212 can be configured for detecting an access to the JPI 206.

The access detector 212 can be further configured for identifying the associated joinpoint, for example through data configured for the access detector 212 by the aspect binder 202 and/or through locating an associated aspect specification and processing the pointcut specification and/or aspect specification as described above. The access detector 212 can be configured for being invoked by the processor 208 prior to accessing the JPI 206 by the processor 208 for executing. Alternatively, the access detector 212 can be configured for being invoked in response to the processor accessing the processor memory location associated with the JPI 206. This can be configured by the aspect binder 202 by replacing the JPI 206 stored in the memory location with a software interrupt machine code instruction and configuring an associated access detector 212 as the interrupt handler for the interrupt generated.

An access detector 212 can be invoked during the execution of the JPI 206 by invoking the access detector 212 in a separate thread, process, and/or processor from the thread, process, and/or processor 208 accessing the processor memory location of the JPI 206. In a further alternative, an access detector 212 associated with a joinpoint and/or potential joinpoint can be invoked after the access by the processor 208 of the processor memory location for storing the JPI 206. Regardless of the configuration, an access detector 212 detects the access of a machine code instruction 206 for processing by a processor 208 where the machine code instruction 206 is in a joinpoint and/or potential joinpoint.

In the aspect configuration illustrated in FIG. 3, the advice specification 316A includes an <execute> element 326A as content of the <symbol> element 322A. The <execute> element 326A in the example advice specification includes an “association” attribute for indicating a relationship between the invocation of the access detector 212 and the access of the associated JPI 206. The “association” attribute can be assigned a value including a keyword specified by the associated advice specification schema. The keyword “parallel” can be defined to indicate the access detector 212 can be executed during the execution of the associated joinpoint and/or potential joinpoint meaning the access detector 212 can be invoked prior to or during the execution of the JPI 206. The “after” keyword indicates in the example, that the access detector 212 can be to be invoked after the processor 208 accesses the JPI 206. The “∥” symbol indicates that either is acceptable as specified by the advice specification.

Referring to FIG. 4, where the MMS 410 is an SDSS based MMS 410; an access detector 212 can be configured for intercepting the flow of execution associated with an access to the JPI 206. The invocation of an access detector 212 can indicate for a particular pointcut an access to an associated JPI 206 is about to occur, is occurring, or has just occurred. For another access detector 212, an invocation can indicate detection of an access to a machine code instruction for executing by the processor 208 in a joinpoint and/or potential joinpoint included in one of several associated pointcuts. A “generic” access detector 212 described above can be just such an access detector 212. Some “pointcut” access detectors 212 can be configured with information identifying more than one pointcut associated with the access detector 212. In FIG. 6C, a link, as depicted by the link 616A, from the machine code of the “addlt” addressable entity in record 612 can be directed to the access detector 212 with machine code stored in code block table 602 record 618 rather than to the “error” addressable entity stored with machine code stored in the record 608. The access detector 212 intercepts an attempt by the processor 208 to access the JPI 206.

The access detector 212 in FIG. 6C can be configured for determining whether the access is for an actual JPI 206. When a joinpoint is not identified by the access detector 212 interoperating with the aspect binder 202, the access detector 212 can allow the “error” addressable entity to be called normally even though an access to a machine code instruction in a joinpoint for executing by the processor 208 is not detected. If an access to a machine code instruction in a joinpoint is detected by the access detector 212, the access detector 212 can be preconfigured for calling the “log” advice operation 214 in record 620. Alternatively, the access detector 212 can be configured for determining the advice operation 214 is the “log” addressable entity based on the associated advice specification as described above.

Returning to FIG. 1, in block 108 the advice operation is invoked in association with detecting the access to the machine code instruction. Accordingly, a system for invoking an advice operation associated with a joinpoint includes means for invoking the advice operation in association with detecting the access to the machine code instruction. For example, as illustrated in FIG. 2, the access detector 212 component is configured for invoking the advice operation in association with detecting the access to the machine code instruction.

When an access to a machine code instruction by the processor 208 for executing is detected where the machine code instruction is in a joinpoint specified by a pointcut specification, an operation specified by an “advice specification” associated with the pointcut specification is invoked by the access detector 212. The operation is referred to as an “advice operation” The term “advice” can refer to an advice specification and/or an advice operation. The context in which the term “advice” is used determines its meaning. Detection of an access to a JPI can occur prior to the actual access, during the access operation, during the execution of the JPI, and/or after the access and execution of the JPI. In FIG. 2 and in FIG. 4, the advice operation 214 can be invoked by the access detector 212.

Referring to FIG. 3, the advice operation 214 matches an addressable entity as specified by the <aentity> element 318A in the second machine code component 204B as specified by the <component> element 320A. The addressable entity can be associated with the symbol “log” as specified by the <symbol> element 322A. The “log” advice operation 214 can be invoked in parallel with the execution of the associated JPI 206 and/or can be invoked after the execution of the JPI 206 as specified by the <execute> element 326A.

Referring again to FIG. 4, where the MMS 410 is an SDSS based MMS 410; the access detector 212 invokes the identified advice operation 214 causing the advice operation 214 to be performed via execution of at least a portion of the advice operation 214 machine code instructions by the processor 208. Alternatively, the access detector 212 can invoke an advice operation 214 included in an addressable entity other than the access detector 212. With respect to the advice specification specified by the <advice> element 316A, the advice operation 214 can be a “log” addressable entity that generates a record in an associated log based on accessible data including, for example, the thread ID, component identifier, symbol, parameters, and returned data of the instance of the addressable entity 408 including the JPI 206 associated with the detected access by the processor 208.

The access detector 212 in FIG. 6C can be configured with information identifying the “log” advice operation 214 as indicated by a static link 616C established by the aspect binder 202 interoperating with the MMS 410 during association of the access detector 212 with the JPI 206. Alternatively, the access detector 212 in FIG. 6C can be configured for determining the advice operation 214 based on the advice specification associated with the joinpoint. Based on the <advice> element 316A the “log” advice operation 214 with machine code stored in code block table 602 record 620 in FIG. 6C can be identified as described above. The static link 616C can be established in the access detector 212 in record 618 for future use based on the advice specification. Alternatively, the link 616C can be a dynamic link determined each time the access detector 212 can be executed based on the advice specification. The access detector 212 can be configured for invoking the “log” advice operation 214 machine code in the record 620 after execution of the JPI 206 as indicated by the <execute> element 326A in FIG. 3. In FIG. 6C, the access detector 212 can be configured for invoking the “log” advice operation 214 in parallel with the execution of the JPI 206 by the processor 208 as indicated by the double arrow depicted on the link 616C. A double arrow on a link indicates as described above an asynchronous invocation.

In FIG. 6D, the access detector 212 and the advice operation 214 are the same addressable entity with machine code stored in the record 620 of the code block table 602. The aspect binder 202 can be configured for establishing a static link in the machine code instructions in, for example, the record 608 of the error addressable entity for invoking the “log” advice operation 214 in correspondence with detecting an access to the JPI 206 included in the “addlt” machine code instructions or included in the “error” machine code instructions. Based on the <execute> element 326A, FIG. 6D indicates the “log” advice operation 214 machine code in the record 620 can be called after the execution of the JPI 206 since the link 616D has a single arrow end indicating a synchronous invocation and can be invoked after the execution of the “error” machine code in record 608 as illustrated in FIG. 6D.

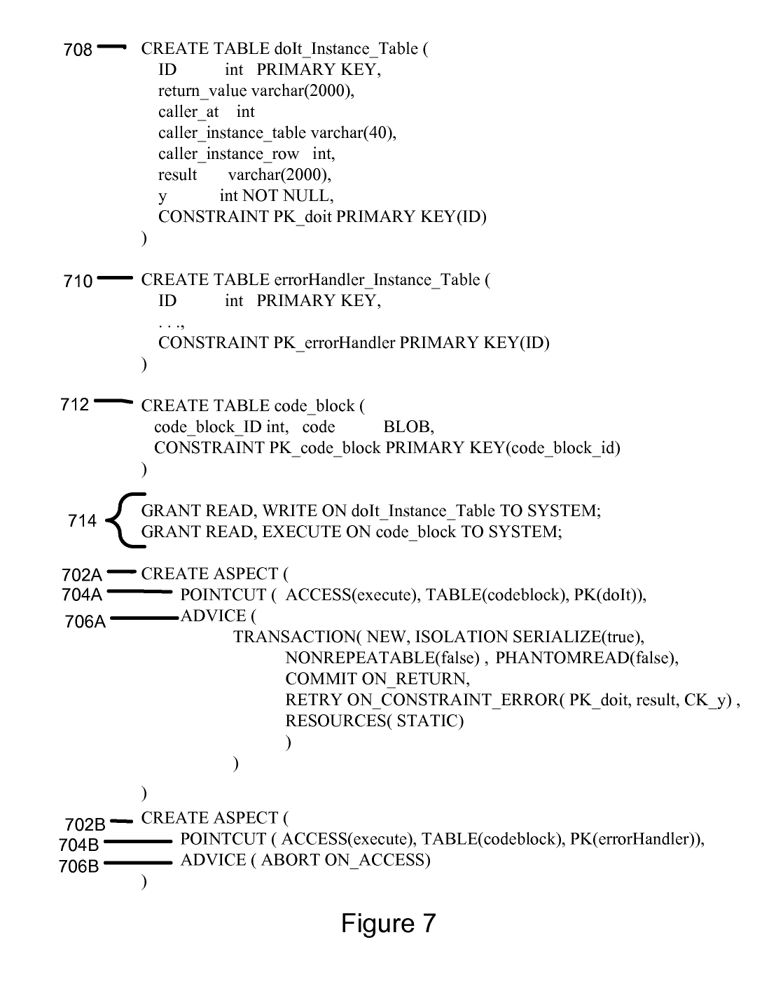

FIG. 7 illustrates a portion of the loadable object code 508 compatible with an SDSS based execution environment 402 including an SDSS based MMS 410. A schema associated with the object code can provide a SQL-like command language extended by an aspect schema portion for configuring an aspect specification 702. The aspect schema can includes a pointcut schema portion for configuring a pointcut specification and an advice schema portion for configuring an advice specification. The portion illustrates an example of a portion of a loadable object code file as described in U.S. patent application Ser. No. 11/428,273 entitled “METHODS, SYSTEMS, AND COMPUTER PROGRAM PRODUCTS FOR PROVIDING A PROGRAM EXECUTION ENVIRONMENT”, and U.S. patent application Ser. No. 11/428,338 entitled “METHODS, SYSTEMS, AND COMPUTER PROGRAM PRODUCTS FOR PROVIDING ACCESS TO ADDRESSABLE ENTITIES USING A NON-SEQUENTIAL VIRTUAL ADDRESS SPACE” using an SDSS based execution environment 402.

The portion includes exemplary instructions used by a loader/linker 406 to create an instance table for a function, such as the “dolt” addressable entity. A first aspect specification 702A in FIG. 7 can include a pointcut specification 704A for identifying a joinpoint for associating with a new transaction. The advice specification 706A can be for identifying an advice operation for creating a new transaction associated with an access by the processor 208 for executing a machine code instruction 206 in the determined joinpoint. A second aspect specification 702B can include a pointcut specification 704B for identifying a joinpoint associated with ending an existing transaction. An advice specification 706B can be for identify an advice operation for aborting a transaction associated with a machine code instruction in the joinpoint.

FIG. 7 includes a command 708 for creating a “dolt_Instance_Table” for holding instance data for instantiations of the “dolt” addressable entity. As depicted in FIG. 7, an instance of “dolt” can include a column for a return instance variable, “return_value”; three columns identifying the invoking addressable entity and a return address, “caller_at”, “caller_instance_table”, and “caller_instance_row”; an input parameter, “y”; and an instance variable, “result”. In an example, “dolt” accesses a static variable and can invoke one or more other addressable entities during its operation that also can access one or more static variables. Static variables can be stored in type tables (not shown) based on the data type of the static variable. The SDSS based MMS 410 can creates a “dolt_Instance_Table” in processor memory 210 including the columns specified in response to processing the CREATE TABLE command 708.

A second CREATE TABLE command 710 can be provided for creating an “errorHandler_Instance_Table” for holding instance data for instantiations of the “error” addressable entity. FIG. 7 illustrates only a portion of the command 710 due to space limitations. A third CREATE TABLE command 712 can be provided for creating a “code_block” table for storing machine code instructions of executable addressable entities such as the “dolt” and “error” functions. A number of exemplary permission commands using a “GRANT” keyword are provided for controlling access to data in the processor memory by machine code program components 204 and security principals, such as the example principal identified by the name “SYSTEM”.

The first aspect specification 702A can be indicated by a “CREATE” command followed by an “ASPECT” keyword as specified by the associated aspect schema. According to the schema a “POINTCUT” keyword can be included for configuring a pointcut specification. The content of the pointcut specification includes matching criteria indicating that a joinpoint is determined by an access for executing a machine code instruction in a record in the “codeblock” where the record's primary key matches the string “dolt”. When an access to a joinpoint in the pointcut identified via the pointcut specification 704A is detected, the aspect binder 202 interoperating with the MMS 410 determines an advice operation based on the advice specification 706A indicated by an “ADVICE” keyword included in the aspect specification 702A. The content of the advice specification identifies a command for creating a transaction. Command parameters include a “NEW,” indicates whether and when a transaction can be associated with an instance of the joinpoint.

Further, isolation specifications associated with an ISOLATION keyword are depicted. The ISOLATION keyword and associated syntax and grammar are defined for specifying an isolation policy to be enforced for transaction resources when a transaction is associated with a corresponding addressable entity. A COMMIT keyword and associated syntax and grammar can be defined for specifying a successful completion point of a transaction. The COMMIT keyword is associated with a matching criterion, ON_RETURN, for determining when to perform a commit advice operation. Similarly, a RETRY keyword can be followed by matching criterion indicating when a retry advice operation should be performed. A RESOURCES keyword can be provided for specifying a resource set included in the transaction. A STATIC keyword can be defined for indicating all static addressable entities accessed during the transaction are included in the transaction. Transaction resources can be protected according to transaction specifications such as the specified isolation policy.

The second aspect specification 702B can be indicated by a ‘CREATE” command followed by an “ASPECT” keyword as specified by the associated aspect schema. According to the schema, a “POINTCUT” keyword can be included for configuring a pointcut specification. The content of the pointcut specification can include a matching criterion indicating that a joinpoint is identified by an access for executing a machine code instruction in a record in the “codeblock” where the record's primary key matches the string “errorHandler”. When an access to a joinpoint in the pointcut specified by the pointcut specification 704B is identified, the aspect binder 202 interoperating with the MMS 410 identifies an advice operation based on the advice specification 706B indicated by an “ADVICE” keyword included in the aspect specification 702B. The advice specification 706B includes a single command, “ABORT ON_ACCESS”, defined for specifying that if an instance of “errorHandler” is accessed under control of a transaction, the transaction is to be aborted and rolled back. In an example, instances of “dolt” 206 invoke an instance of “errorHandler” when an error condition is detected, thus an access to an instance of “errorHandler” is specified as a boundary of a transaction where the transaction is to be aborted.

Referring to FIG. 4 and FIG. 5, in an alternative, the MMS 410 can be configured as a conventional MMS supporting a non-structured, sequential address space. The loader/linker 406 can be configured for accessing a map of the loadable object code 508 and a corresponding symbol table to generate a runtime memory map and symbol table during the loading and linking of the loadable object code 508. During loading of an addressable entity, such as the addressable entity 408, the loader/linker 406 can provide metadata included in the memory map and the symbol table associated with the addressable entity 408 to the aspect binder 202. The aspect binder 202 can be configured for retrieving a pointcut specification from the aspect specification database 416 for determining whether the addressable entity 408 includes a joinpoint.

The memory map and symbol table generated by the compiler 504 and loader/linker 406 can include a language specific symbol for an addressable entity. An alias symbol can be configured by a user via the GUI 414 or generated automatically by one of the compiler 504 and loader/linker 406.

The aspect binder 202 can be configured for retrieving a preconfigured list of addressable entity symbols each associated with a respective machine code instruction in a machine code program component 204. The aspect binder 202 determines a processor memory location for storing a machine code instruction associated with each of the symbols by locating each symbol in a symbol table to determine a processor memory address within a loaded machine code program component 204. A system memory map lookup by the aspect binder 202 returns a starting address of a segment of the machine code program component 204 loaded into the processor memory 210. In this manner, the aspect binder 202 determines joinpoints and associated JPI's. The list can be generated by, for example, the aspect binder 202, based on pointcut specifications. In various alternatives, the aspect binder 202 can be configured for determining joinpoints and/or potential joinpoints prior to loading a machine code program component 204, at load/link time, and/or at execution time of machine code instructions included in the machine code program component 204 by the processor 208.

At load/link time, the aspect binder 202 can be configured for determining that a machine code instruction, such as the machine code instruction 206, can be associated with a joinpoint based on a pointcut specification. The aspect binder 202 can access attributes for joinpoint identification from a memory map of a machine code program component 204 including the machine code instruction 206, an associated symbol table, other memory maps and symbol tables, and/or any attribute available at the time of the determination from the execution environment 402 and included components. For example, a determination can be performed by the loader/linker 406 detecting an unresolved symbol at link time for an addressable entity where the symbol matches a matching criterion in a pointcut specification. Based on the matching symbol the loader/linker 406 can be configured for interoperating with the aspect binder 202. The aspect binder 202 can perform further determination based on the pointcut specification if needed. Based on the determination operation, a machine code instruction 206 can be identified to be one of a JPI, a potential JPI, or it is determined that there is no joinpoint associated with the machine code addressable entity 408 associated with the symbol.

Alternatively, the processor memory address of the machine code representation of an addressable entity can be determined by the loader/linker 406 using a symbol table, and the address of the addressable entity 408 can be detected in the machine code instructions in a machine code program component 204. The aspect binder 202 interoperating with the loader/linker 406 determines that the pointcut specification matching criterion matches the attributes associated with the machine code instruction 206, determined to be a JPI. The processor memory location of the JPI 206 can be associated with the joinpoint and/or potential joinpoint via any of the mechanisms described above.

For example, the aspect binder 202 can be configured for replacing the machine code instruction in the processor memory location of the JPI 206 with a software interrupt machine code instruction, and to configure an access detector 212 as an interrupt handler for the interrupt machine code instruction. The access detector 212 can be configured for ensuring the replaced machine code instruction can be executed by the processor 208 when the access detector 212 can be invoked in response to an access of the processor memory location by the processor 208 for executing.

The loader/linker 406 can be configured for detecting each addressable entity in a machine code program component 204 at load/link time. For each detected addressable entity, the loader/linker 406 can be configured for providing attribute information associated with the detected addressable entity to the aspect binder 202. The aspect binder 202 based on the attribute information and/or attribute information available from the execution environment 210 can search aspect specification information records stored in an aspect specification database 426 for a record with pointcut specification information that matches at least a portion of the attribute information. If a record is not found, the loader/linker 406 continues loading the addressable entity. If a matching record is located, the aspect binder 202 can be configured for providing a response to the load/linker 406. The response provides for associating the processor memory location of the machine code instruction 206 with aspect information based on the matching aspect information record. The aspect information associated with the machine code instruction 206 can vary depending on whether the machine code instruction 206 is a potential JPI and/or is a determined JPI, as described above.

When a joinpoint is determined, the aspect binder 202 can be configured for providing an access detector 212 associated with an access by the processor 208 of a selected JPI 206 associated with the joinpoint. The access detector 212 can be a “generic”, “pointcut”, or “joinpoint” aspect detector 212 as described above.

An access by the processor 208 to the processor memory location associated with the JPI 206 can result in loading the interrupt machine code instruction described above into the processor 208. Execution of the interrupt machine code instruction generates an interrupt causing the configured aspect detector 212 to be invoked. As described above, the access detector 212 can be a determined advice operation 214, or invoke the advice operation 214 when the advice operation 214 is determined at joinpoint identification time. Alternatively, also described above, the advice operation 214 can be determined by the access detector 212 based on the advice specification. When the replaced machine code instruction is a potential JPI, the access detector determines whether an actual joinpoint is associated with the replaced machine code instruction based on at least a portion of the pointcut specification as described above.

In an alternative, physical memory supporting the processor memory 210 can be configured for generating one or more hardware interrupts based on a setting of a processor memory location when accessed by the processor 208. The aspect binder 202 can be configured for setting a hardware interrupt associated with a determined JPI 206. The aspect detector 202 can be further configured for establishing an appropriate access detector 212 as an interrupt handler for the set hardware interrupt. The remainder of the operation is analogous to that described based on setting a software interrupt.

The access detector 212, invoked by the various interrupt based alternatives described, can be configured for being processed prior to; during using a separate thread, process, and/or processor; and/or after processing of the machine code instruction 206 depending on the aspect specification, the execution environment 402, and the configuration of the aspect binder 202.

Alternatively, the aspect binder 202 can be configured for interoperating with the MMS 410 to mark a region of processor memory 210 including a determined joinpoint and/or potential joinpoint. A joinpoint and associated JPI 206 can be identified using any of the above described methods and systems. When a joinpoint and/or potential joinpoint is determined a processor memory region, such as a page, including a processor memory location for storing the JPI 206 can be marked by the MMS 410 as directed by the aspect binder 202. The MMS 410 can be configured for storing a value in a header portion or other portion of a processor memory region allocated for storing metadata.

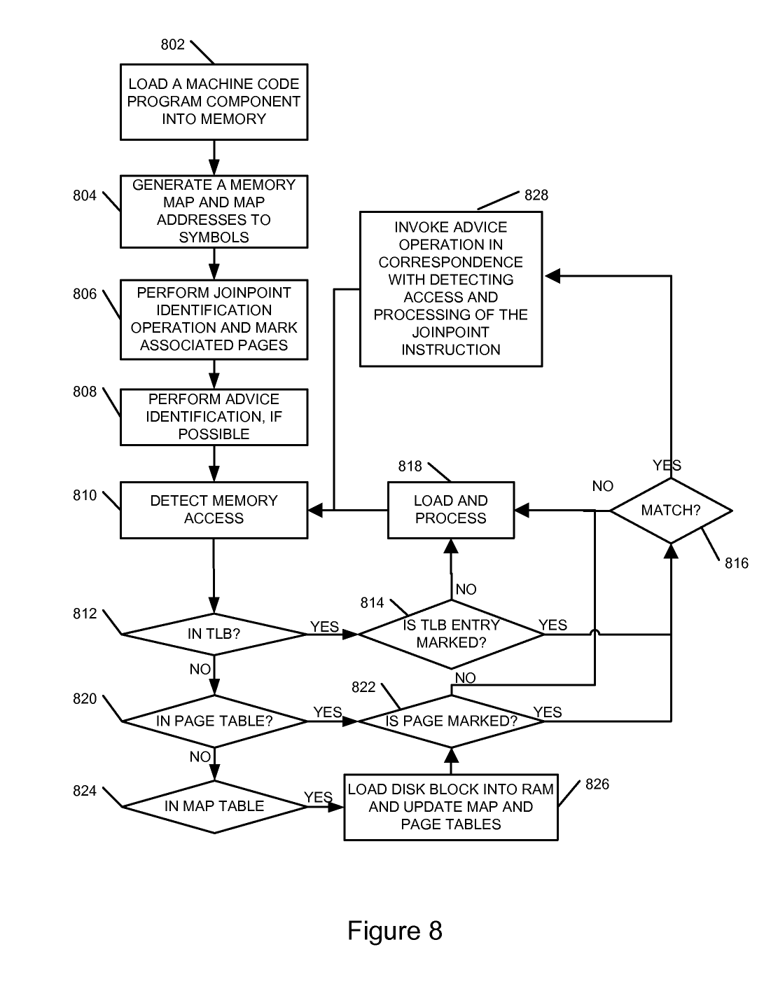

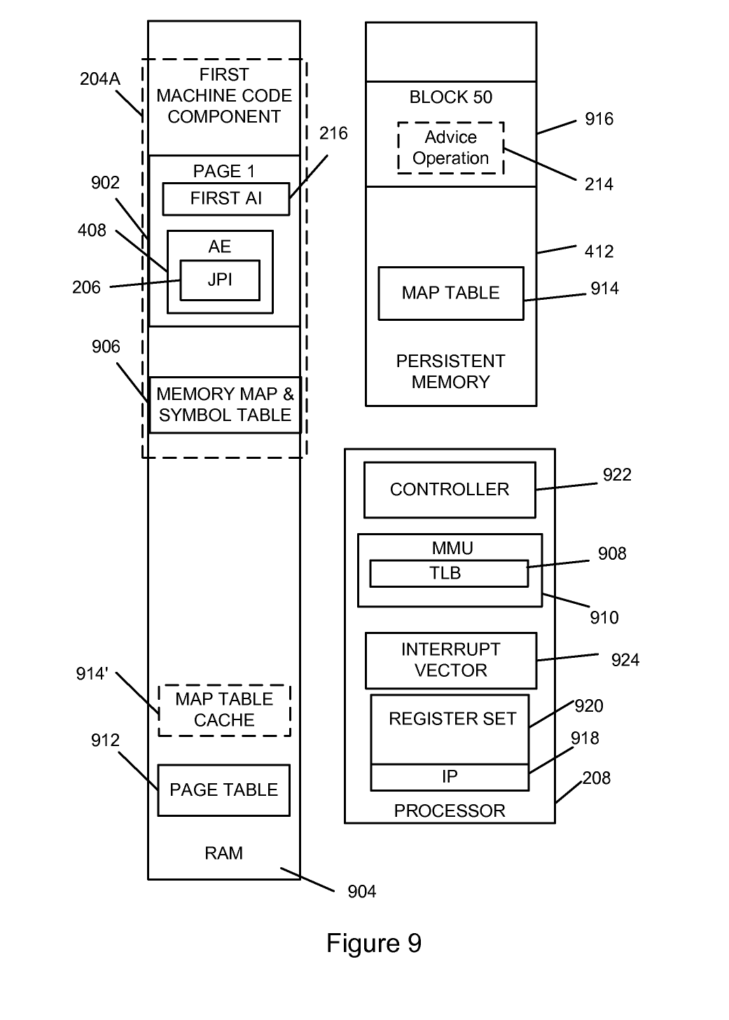

FIG. 8 depicts a flow diagram compatible with the flow diagram illustrated in FIG. 1 where the flow diagram in FIG. 8 is associated with the arrangement illustrated in FIG. 4 and the arrangement illustrated in FIG. 9. At least a portion of the components illustrated in FIG. 4 and the arrangement illustrated in FIG. 9 are configured for performing the methods illustrated in FIG. 1 and FIG. 8. The MMS 410 can be configured for marking regions of processor memory including a JPI.

In block 802 in FIG. 8, the loader/linker 406 loads and, if necessary, links, the loadable object code 508 into processor memory 210 creating the first machine code program component 204A. In FIG. 9, the processor memory can be paged, thus at least a portion of the first machine code program component 204A can be loaded into a page, depicted as a page 1 902 in FIG. 9. Page 1 902 can be loaded into physical processor memory depicted as a RAM 904 for accessing by the processor 208.

In block 804, the loader/linker 406 generates a runtime memory map and symbol table based on a map and symbol table associated with the loadable object code 508 as described above. In FIG. 9, the runtime memory map and symbol table associated with the first machine code program component 204A are depicted as a memory map and symbol table 906 stored in page 1 902 of the processor memory.

In block 806, the aspect binder 202, interoperating with the loader/linker 406, performs one or more joinpoint identification operations based on attribute information available from the memory map and symbol table 906, other memory maps and symbol tables available, and/or attributes available within the execution environment 402. When a joinpoint and/or potential joinpoint is identified, the aspect binder 202 interoperating with the MMS 410 marks a page, such as page 1 902, including the processor memory location of the associated JPI 206. In FIG. 9 and FIG. 4 the JPI 206 is the machine code instruction included in the addressable entity 408. References managed by the MMS 410 can be marked rather than marking referenced pages including the identified JPI 206. A reference to a processor memory location can be stored in an entry in a table lookaside buffer (TLB) 908 included in an MMU 910 in the processor 208, included in a page table 912 at least partially stored in the RAM 904, and for an SDSS based MMS 410 included in an optional map table 914 with an optional map table cache 914′.

An advice operation 214 can be identified based on an associated advice specification at block 806 at load/link time and/or can be identified at runtime in correspondence with blocks 808 and/or 828 depending on the aspect specification and the aspect binder 202 configuration. In FIG. 9, the advice operation 214 is stored in persistent memory 412 in disk block 50 916. The block 50 916 can store a portion of a page file for a MMS 410 based on conventional virtual processor memory. Alternatively, the block 50 916 in persistent memory 412 can store a portion of processor memory 210 associated with an address in a processor address space of an SDSS based MMS 410 supported by the processor 208 or by a virtual machine execution environment.

According to an aspect, the access detector 212 can be the MMS 410. When the processor 208 accesses a processor memory location for processing, the MMS 410 can detect the access in block 810. For example, an address of the processor memory location can be stored in a machine code instruction pointer (IP) register 918 for accessing a next machine code instruction for executing by the processor 208. The IP register 918 in FIG. 9 can be included in a register set 920 supported by the processor 208. The processor 208 can also include a controller 922 for performing processor operations encoded in machine code instructions and an arithmetic logical unit (ALU) (not shown) for performing arithmetic calculations.

In block 812, the MMU 910 included in the MMS 410 can determine whether the accessed processor memory location addressed by the IP register 918 has been accessed recently by checking for an entry in the TLB 908 associated with the processor memory location. If an entry in the TLB 908 associated with the processor memory location is located, then processing proceeds to block 814. In block 814 the MMU 910 can determine whether the entry in the TLB 908 is marked. If the entry is marked, the MMU 910 can be configured for triggering an interrupt in an interrupt vector 924 resulting in processing to proceed to block 816. If the entry is not marked, processing proceeds to block 818 where the MMU 910 can provide for the accessed processor memory location to be loaded into and processed by the processor 208. When the processor 208 accesses a next location in the processor memory 210, control returns to block 810.

Returning to the description of block 812, if no entry associated with the processor memory location accessed by the processor 208 is in the TLB 908, the processor 208 can generate an interrupt via the interrupt vector 924 resulting in processing proceeding to block 820. The MMS 410 can be preconfigured as an interrupt handler associated with the interrupt generated in block 812. In block 820, the MMS 410 can determine whether the page 1 902 including the accessed processor memory location addressed by the IP register 918 is stored or cached in physical processor memory depicted as the RAM 904. If an entry in the page table 912 associated with the page 1 902 is located, the MMS 410 can determine from the entry whether the page 1 902 is in the RAM 904 or in persistent memory 412, such as a page file supported by a conventional MMS 410. The MMS 410 can ensure the page 1 902 is stored in the RAM 904 before processing proceeds to block 822. In block 822 the MMS 410 can determine whether the entry in the page table 912 is marked. If the entry is marked, then the MMS 410 can invoke the aspect binder 202, and in response, processing proceeds to block 816. If the entry in the page table 912 is not marked, the MMS 410 can provide the RAM address of the accessed processor memory location to the MMU 910 and processing proceeds to block 818 where the MMU 910 can provide for the accessed processor memory location to be loaded into and processed by the processor 208. When the processor 208 accesses a next location in the processor memory 210 control returns to block 810.

In an SDSS based MMS 410 processor memory 210 can include at least a portion of the persistent memory 412. A map table 914 and an optional map table cache 914′ can be provided for the SDSS based MMS 410 for managing processor memory 210 stored in the persistent memory 412. Returning to the description of block 820, if no entry associated with the processor memory location accessed by the processor 208 is in the page table 912, the MMS 410, when configured as an SDSS based MMS 410, can be configured proceeding to block 824 for checking the map table 914 and or map table cache 914′. The MMS 410 can determine whether the page 1 902 including the accessed processor memory location 206 addressed by the IP register 918 are stored in the processor memory 210 mapped to a region of the persistent memory 412. When the MMS 410 locates an entry in the map table 914 and/or map table cache 914′ associated with the page 1 902, processing can proceed to block 826. In block 826, the MMS 410 can determine a free region in the RAM 904 for loading the page 902 or can determine a page in the RAM 904 that can be removed. If the page to be removed has been updated the MMS 410 can synchronize the page in the RAM 904 with a copy in the persistent memory 412. When a free region in the RAM 904 is available, the page 1 902 can be loaded into the region. The MMS 410 can create a page table 912 entry for the page 902. If the map table 914 entry for the page 1 902 is marked, the MMS 410 can mark the new page table 912 entry. Processing proceeds to block 822. Block 822 is described above.

As described, if a location or region in the processor memory 210 is marked in at least one of the TLB 908, the page table 912, and the map table 914 and/or map table cache 914′ the flow of processing includes block 816. In block 816 the aspect binder 202 is configured for determining whether the accessed processor memory location is in a joinpoint. The aspect binder 202 can determine whether at least a portion of attributes available at the time satisfy matching criterion of a pointcut specification as described above. Thus, the aspect binder 202 can be a portion of the access detector 212 along with the MMS 410. If the aspect binder 202 determines a pointcut specification matching criterion that is satisfied, processing proceeds to block 828. In block 824 an advice determination operation can be performed by the aspect binder 202 based on an advice specification associated with the pointcut specification of the JPI 206. The advice invocation operation in block 828 can include an operation to complete an advice identification operation performed in block 806 by the MMS 410

In block 828, the identified advice operation 214 is invoked in correspondence with the detecting of the access of the machine code instruction 206 as a JPI associated with the pointcut specification. The advice operation 214 can be performed before, during, and/or after the execution of the joinpoint as described above.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for invoking an advice operation associated with a joinpoint, the method comprising:
identifying, based on a pointcut specification included in an aspect specification, a joinpoint in a machine code program component, the joinpoint including a machine code instruction;
identifying, based on an advice specification included in the aspect specification, an advice operation included in a machine code program component;
detecting an access to the machine code instruction in the joinpoint for execution by a processor; and
invoking the advice operation in association with detecting the access to the machine code instruction.

2. The method of claim 1 wherein the pointcut specification conforms to a schema for specifying a pointcut specification for determining a joinpoint included in a machine code program component generated from source code written in any of a plurality of programming languages.

3. The method of claim 1 wherein the aspect specification is specified in a first programming language and the machine code program component is generated from source code in a second programming language.

4. The method of claim 1 wherein the machine code program component including the joinpoint is generated in a first machine code language for execution on a first processor and a machine code program component including the advice operation is generated in a second machine code language for execution on a second processor.

5. The method of claim 1 wherein the aspect specification includes a matching criterion for identifying a joinpoint, the matching criterion based on at least one of an attribute of an addressable entity, an attribute of a relationship between a plurality of addressable entities, and an execution environment attribute.

6. The method of claim 1 wherein the joinpoint is identified in a first instance of an addressable entity and wherein the joinpoint is not identified in a second instance of the addressable entity.

7. The method of claim 1 further comprising associating aspect information with a processor memory location including the machine code instruction based on the aspect specification.

8. The method of claim 7 wherein the processor memory location is identified by a processor virtual memory address included in at least one of a structured processor memory address space, a non-sequential processor memory address space, and a sequential processor memory address space.

9. The method of claim 1 wherein claim 7 wherein a portion of the processor memory including the processor memory location is marked for detecting the access.

10. The method of claim 1 wherein the advice specification conforms to a schema for advice specifications for identifying an advice operation included in a machine code program component generated from source code written in any of a plurality of programming languages.

11. A system for invoking an advice operation associated with a joinpoint, the system comprising:
means for identifying, based on a pointcut specification included in an aspect specification, a joinpoint in a machine code program component, the joinpoint including a machine code instruction;
means for identifying, based on an advice specification included in the aspect specification, an advice operation included in a machine code program component;
means for detecting an access to the machine code instruction in the joinpoint for execution by a processor; and
means for invoking the advice operation in association with detecting the access to the machine code instruction.

12. A system for invoking an advice operation associated with a joinpoint, the system comprising:
an aspect binder component configured for identifying, based on a pointcut specification included in an aspect specification, a joinpoint in a machine code program component, the joinpoint including a machine code instruction;
the aspect binder component configured for identifying, based on an advice specification included in the aspect specification, an advice operation included in a machine code program component;
an access detector component configured for detecting an access to the machine code instruction in the joinpoint for execution by a processor, and configured for invoking the advice operation in association with detecting the access to the machine code instruction.

13. The system of claim 12 wherein the pointcut specification conforms to a schema for specifying a pointcut specification for determining a joinpoint included in a machine code program component generated from source code written in any of a plurality of programming languages.

14. The system of claim 12 wherein the aspect specification is specified in a first programming language and the machine code program component is generated from source code in a second programming language.

15. The system of claim 12 wherein the machine code program component including the joinpoint is generated in a first machine code language for execution on a first processor and a machine code program component including the advice operation is generated in a second machine code language for execution on a second processor.

16. The system of claim 12 wherein the aspect binder component is configured for identifying a joinpoint based on a matching criterion included in the aspect specification, wherein the matching criterion based on at least one of an attribute of an addressable entity, an attribute of a relationship between a plurality of addressable entities, and an execution environment attribute.

17. The system of claim 12 wherein the aspect binder component is configured for identifying the joinpoint in a first instance of an addressable entity and for not identifying the joinpoint in a second instance of the addressable entity.

18. The system of claim 12 further comprising a memory management system component configured for associating aspect information with a processor memory location including the machine code instruction based on the aspect specification.

19. The system of claim 18 wherein the memory management system component component is configured for identifying the processor memory location by a virtual processor memory address included in at least one of a structured processor memory address space, a non-sequential processor memory address space, and a sequential processor memory address space.

20. The system of claim 12 wherein the access detector component is configured for marking a portion of the processor memory including the processor memory location for detecting the access.

21. The system of claim 12 wherein the advice specification conforms to a schema for advice specifications for identifying an advice operation included in a machine code program component generated from source code written in any of a plurality of programming languages.

22. A computer readable medium embodying a computer program, executable by a machine, for invoking an advice operation associated with a joinpoint, the computer program comprising executable instructions for:
identifying, based on a pointcut specification included in an aspect specification, a joinpoint in a machine code program component, the joinpoint including a machine code instruction;
identifying, based on an advice specification included in the aspect specification, an advice operation included in a machine code program component;
detecting an access to the machine code instruction in the joinpoint for execution by a processor; and
invoking the advice operation in association with detecting the access to the machine code instruction.
